(19) United States
(12) Patent Application Publication
(10) Pub. No.: US 2022/0229696 A1
(43) Pub. Date: Jul. 21, 2022

(54) DATA PROCESSING EXECUTION DEVICE, DATA PROCESSING EXECUTION METHOD AND COMPUTER READABLE MEDIUM

(71) Applicant: Mitsubishi Electric Corporation, Tokyo (JP)

(72) Inventors: Tsutomu MOTOHAMA, Tokyo (JP); Masahiro DEGUCHI, Tokyo (JP); Masahiro HIRAMORI, Tokyo (JP); Hidetoshi OKI, Tokyo (JP)

(73) Assignee: Mitsubishi Electric Corporation, Tokyo (JP)

(21) Appl. No.: 17/716,780

(22) Filed: Apr. 8, 2022

Related U.S. Application Data
(63) Continuation of application No. PCT/JP2019/048681, filed on Dec. 12, 2019.

(51) Int. Cl. G06F 9/48

(52) U.S. Cl. CPC G06F 9/4887; G06F 9/4818

(57) ABSTRACT

Each of a plurality of engines executes data processing. While any engine of the plurality of engines is executing data processing as an execution engine, an engine selection unit (102) selects a takeover engine to take over execution of execution data processing being data processing executed by the execution engine, from the plurality of engines. An engine execution management unit (103) makes the execution engine suspend execution of the execution data processing, and makes the takeover engine take over execution of the execution data processing.

### CROSS REFERENCE TO RELATED APPLICATION

This application is a Continuation of PCT International Application No. PCT/JP2019/048681, filed on Dec. 12, 2019, which is hereby expressly incorporated by reference into the present application.

### TECHNICAL FIELD

The present invention relates to a scheduling technique of data processing.

### BACKGROUND ART

As a technique regarding scheduling of data processing, there exists a technique disclosed in Patent Literature 1.

Patent Literature 1 discloses a technique to select an engine capable of completing data processing by a deadline, from a plurality of engines to execute data processing. For example, according to the technique in Patent Literature 1, an engine whose operational accuracy is low but processing time is short, or an engine whose operational accuracy is high but processing time is long, is selected.

### CITATION LIST

### Patent Literature

Patent Literature 1: WO2018-198823 A

### SUMMARY OF INVENTION

### Technical Problem

According to the technique in Patent Literature 1, at the start of data processing, an engine capable of completing data processing within a deadline is selected. Therefore, in the technique in Patent Literature 1, when after starting execution of certain data processing (hereinafter referred to as “data processing A”), new data processing (hereinafter referred to as “data processing B”) with priority higher than the data processing A occurs due to an accidental event, there occurs a case wherein it is impossible to complete the data processing A by the deadline.

That is, when the data processing B with higher priority occurs after starting execution of the data processing A, execution of the data processing A is interrupted so as to prioritize execution of the data processing B. Then, after completing the data processing B, execution of the data processing A is resumed. According to Patent Literature 1, an engine applied to the data processing A is fixed at the start of the data processing A and unchangeable afterward. Therefore, according to the technique in Patent Literature 1, it is impossible to complete the data processing A by the deadline when an accidental event occurs.

As described above, in the technique in Patent Literature 1, there is a problem that it is impossible to perform scheduling of data processing flexibly in response to change of a situation, since an engine to execute the data processing is fixed.

The present invention is aimed at solving this kind of problem. More specifically, the present invention is mainly aimed at making it possible to perform scheduling of data processing flexibly in response to change of a situation.

### Solution to Problem

There is provided according to one aspect of the present invention a data processing execution device includes:

a plurality of engines, each of which executes data processing;

an engine selection unit to select, while any engine of the plurality of engines is executing data processing as an execution engine, a takeover engine to take over execution of execution data processing being data processing executed by the execution engine, from the plurality of engines; and

a control unit to make the execution engine suspend the execution of the execution data processing, and to make the takeover engine take over the execution of the execution data processing.

### Advantageous Effects of Invention

According to the present invention, even when an execution engine is executing execution data processing, it is possible to have a takeover engine take over execution of the execution data processing Therefore, according to the present invention, it is possible to flexibly perform scheduling of data processing in response to change of a situation.

### BRIEF DESCRIPTION OF DRAWINGS

FIG. 1 is a diagram illustrating an example of a hardware configuration of a data processing execution device according to a first embodiment;

FIG. 2 is a diagram illustrating an example of a function configuration of the data processing execution device according to the first embodiment;

FIG. 3 is a diagram illustrating a relation among an engine, a degree of operational accuracy, data processing and a priority degree according to the first embodiment;

FIG. 4 is a diagram illustrating an example of an engine list according to the first embodiment;

FIG. 5 is a diagram illustrating an example of an execution data processing list according to the first embodiment;

FIG. 6 is a diagram illustrating an example of an execution standby data processing list according to the first embodiment;

FIG. 7 is a diagram illustrating an example of a block function list and an engine implementation code according to the first embodiment;

FIG. 8 is a diagram illustrating a configuration example of an operation result storage memory according to the first embodiment;

FIG. 9 is a diagram illustrating an example of an execution schedule of data processing in a steady state according to the first embodiment;

FIG. 10 is a diagram illustrating an example of an execution schedule of data processing in a case of occurrence of an accidental event according to the first embodiment;

FIG. 11 is a diagram illustrating an example of an execution schedule of data processing in a case of occurrence of an accidental event according to the first embodiment;

FIG. 12 is a diagram illustrating an example of an execution schedule of data processing in a steady state according to the first embodiment;

FIG. 13 is a diagram illustrating an example of an execution schedule of data processing in a case of occurrence of an accidental event according to the first embodiment;

FIG. 14 is a diagram illustrating an overview of operations of the data processing execution device according to the first embodiment;

FIG. 15 is a diagram illustrating a range of first combination extraction processing according to the first embodiment;

FIG. 16 is a diagram illustrating a range of second combination extraction processing (first time) according to the first embodiment;

FIG. 17 is a diagram illustrating a range of second combination extraction processing (second time) according to the first embodiment;

FIG. 18 is a flowchart illustrating an example of an engine selection unit according to the first embodiment;

FIG. 19 is a flowchart illustrating a detail of the first combination extraction processing according to the first embodiment;

FIG. 20 is a flowchart illustrating a detail of the second combination extraction processing according to the first embodiment;

FIG. 21 is a flowchart illustrating an example of operations of an engine execution management unit according to the first embodiment;

FIG. 22 is a flowchart illustrating an example of operations of the engine execution management unit according to the first embodiment;

FIG. 23 is a flowchart illustrating an example of operations of the engine execution management unit according to the first embodiment;

FIG. 24 is a flowchart illustrating an example of operations of an engine execution unit according to the first embodiment;

FIG. 25 is a diagram illustrating an example of an execution data processing list and an execution standby data processing list at a time=0 according to the first embodiment;

FIG. 26 is a diagram illustrating an example of an execution data processing list and an execution standby data processing list at a time=25 according to the first embodiment;

FIG. 27 is a diagram illustrating an example of an execution data processing list and an execution standby data processing list at a time=150 according to the first embodiment;

FIG. 28 is a diagram illustrating an example of an execution data processing list and an execution standby data processing list at a time=200 according to the first embodiment;

FIG. 29 is a diagram illustrating an example of an execution data processing list and an execution standby data processing list at a time=350 according to the first embodiment;

FIG. 30 is a diagram illustrating an example of an execution data processing list and an execution standby data processing list at a time=425 according to the first embodiment;

FIG. 31 is a diagram illustrating an example of an execution data processing list and an execution standby data processing list at a time=775 according to the first embodiment;

FIG. 32 is a diagram illustrating an example of a function configuration of a data processing execution device according to a second embodiment;

FIG. 33 is a diagram illustrating an example of a timing of conversion processing according to the second embodiment;

FIG. 34 is a diagram illustrating an overview of operations of a conversion processing unit according to the second embodiment; and

FIG. 35 is a diagram illustrating an example of a conversion processing time list according to the second embodiment.

### DESCRIPTION OF EMBODIMENTS

Hereinafter, embodiments of the present invention will be described using diagrams. In the following description and diagrams of the embodiments, the same elements or corresponding elements are denoted by same reference numerals.

### First Embodiment

***Explanation of Configuration***

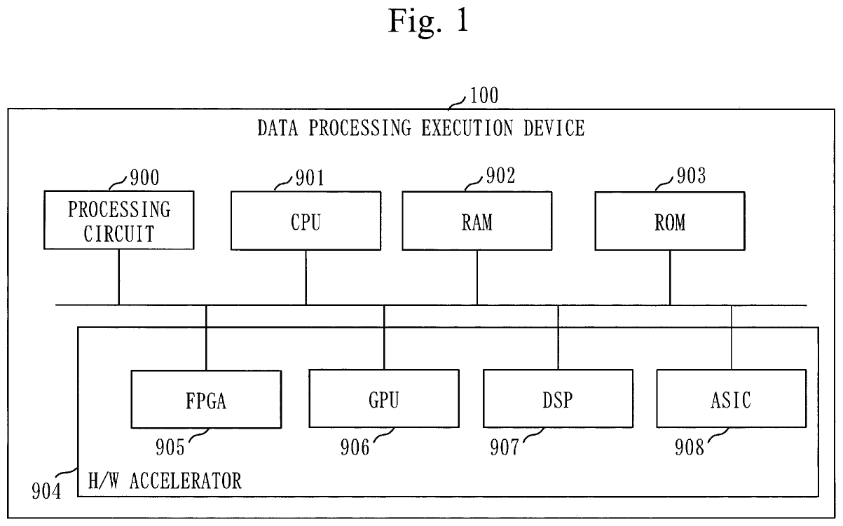

FIG. 1 illustrates an example of a hardware configuration of a data processing execution device 100 according to the present embodiment.

The data processing execution device 100 according to the present embodiment is a computer. A procedure of operations of the data processing execution device 100 corresponds to a data processing execution method. Further, a program to realize operations of the data processing execution device 100 corresponds to a data processing execution program.

The data processing execution device 100 executes data processing. Data processing is digital signal processing to perform analysis, manipulation, classification, conversion, etc. by performing at least either an arithmetic operation or a logical operation on digital signals.

The data processing execution device 100 includes, as hardware components, a processing circuit 900, a central processing unit (CPU) 901, a RAM 902, a ROM 903 and a hardware accelerator 904.

The hardware accelerator 904 includes a field-programmable gate array (FPGA) 905, a graphics processing unit (GPU) 906, a digital signal processor (DSP) 907 and an application specific integrated circuit (ASIC) 908.

The processing circuit 900 is realized by any of a CPU, an FPGA, a GPU, a DSP and an ASIC. The processing circuit 900 has roles different from the FPGA 905, the GPU 906, the DSP 907 and the ASIC 908 realizing an engine to be described below; thus, in order to differentiate the processing circuit 900 from these, a name different from these is used. The processing circuit 900 may be any of the CPU 901, the FPGA 905, the GPU 906, the DSP 907 and the ASIC 908, or may be any of a CPU, an FPGA, a GPU, a DSP and an ASIC different from these. The processing circuit 900 corresponds to processing circuitry. Hereinafter, an example of the processing circuit 900 being a CPU different from the CPU 901 is described.

The processing circuit 900 performs a data processing registration unit 101, an engine selection unit 102, an engine execution management unit 103, an engine execution unit 104 and a communication processing unit 105, to be described below.

The data processing registration unit 101, the engine selection unit 102, the engine execution management unit 103, the engine execution unit 104 and the communication processing unit 105 are realized by a program. That is, the processing circuit 900 executes a program to realize functions of the data processing registration unit 101, the engine selection unit 102, the engine execution management unit 103, the engine execution unit 104 and the communication processing unit 105, and attains the functions of the data processing registration unit 101, the engine selection unit 102, the engine execution management unit 103, the engine execution unit 104 and the communication processing unit 105.

The program to realize the functions of the data processing registration unit 101, the engine selection unit 102, the engine execution management unit 103, the engine execution unit 104 and the communication processing unit 105 is stored in the ROM 903. The program to realize the functions of the data processing registration unit 101, the engine selection unit 102, the engine execution management unit 103, the engine execution unit 104 and the communication processing unit 105 is loaded into the RAM 902, and executed by the processing circuit 900.

Further, at least any of information, data, a signal value and a variable value indicating a result of processing in the data processing registration unit 101, the engine selection unit 102, the engine execution management unit 103, the engine execution unit 104 and the communication processing unit 105 is stored in at least any of the RAM 902, the ROM 903, and a register and a cache memory inside the processing circuit 900.

Furthermore, the program to realize the functions of the data processing registration unit 101, the engine selection unit 102, the engine execution management unit 103, the engine execution unit 104 and the communication processing unit 105 may be stored in a portable record medium such as a magnetic disk, a flexible disk, an optical disc, a compact disc, a Blue-ray (registered trademark) disc and a DVD, etc. Accordingly, it may be applicable to distribute the portable record medium storing the program to realize the functions of the data processing registration unit 101, the engine selection unit 102, the engine execution management unit 103, the engine execution unit 104 and the communication processing unit 105.

Further, “unit” of the data processing registration unit 101, the engine selection unit 102, the engine execution management unit 103, the engine execution unit 104 and the communication processing unit 105 may be replaced with “circuit”, “step”, “procedure” or “processing”.

Each of the CPU 901, the FPGA 905, the GPU 906, the DSP 907, the ASIC 908 is a hardware resource (hereinafter denoted by an H/W resource) to realize an engine to execute data processing.

The engine is a concept into which a hardware resource and software to execute data processing are integrated.

For example, the engine is realized by the CPU 901 to execute a program describing algorithms for data processing.

As an example of the engine, a convolutional neural network (CNN) is cited.

FIG. 1 illustrates, as a hardware resource to realize the engine, the CPU 901, the FPGA 905, the GPU 906, the DSP 907 and the ASIC 908. However, as a hardware resource to realize the engine, it is sufficient when at least one of these exists. That is, the hardware resource to realize the engine may only be the CPU 901, or may be a combination of the CPU 901 and the FPGA 905, or the GPU 906 and the DSP 907.

The relation between the data processing and the engine will be described below.

The data processing execution device 100 may be connected with a device such as a sensor, a display device, an actuator, etc. via a network. Further, the data processing execution device 100 may be connected with a data processing execution device similar in type to the data processing execution device 100 via a network.

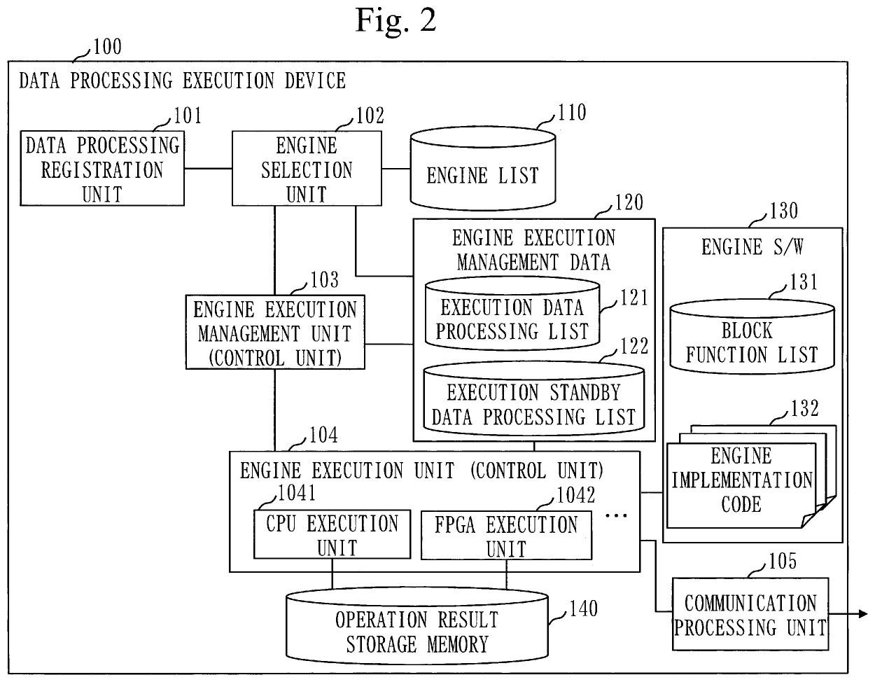

FIG. 2 illustrates an example of a function configuration of the data processing execution device 100 according to the present embodiment.

The data processing execution device 100 according to the present embodiment is configured by the data processing registration unit 101, the engine selection unit 102, the engine execution management unit 103, the engine execution unit 104, the communication processing unit 105, engine execution management data 120, engine software 130 and an operation result storage memory 140.

The engine execution unit 104 is further configured by a CPU execution unit 1041 and an FPGA execution unit 1042.

The engine execution management data 120 is further configured by an execution data processing list 121 and an execution standby data processing list 122.

The engine software 130 is further configured by a block function list 131 and an engine implementation code 132.

Before describing a detail of the function configuration illustrated in FIG. 2, descriptions are made on a relation among an engine, a degree of operational accuracy (hereinafter referred to simply as a degree of accuracy), data processing and a priority degree.

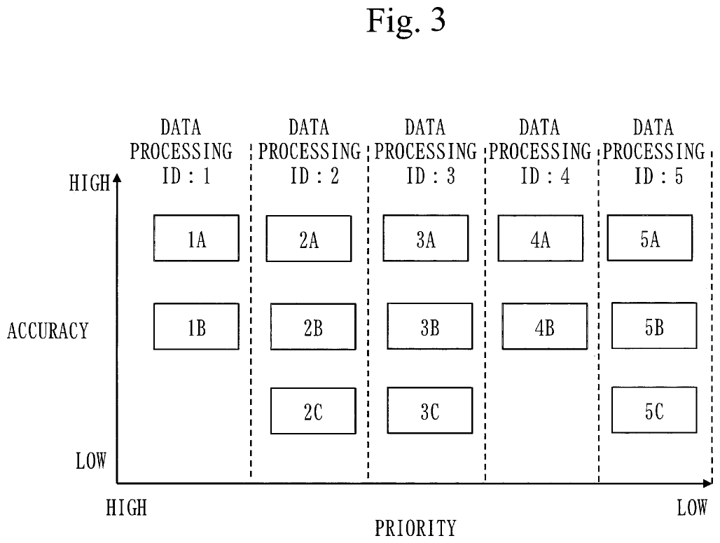

FIG. 3 illustrates the relation among an engine, a degree of operational accuracy, data processing and a priority degree.

The example of FIG. 3 takes as a premise existence of five types of data processing. A data processing identifier (ID) is set to each data processing. The data processing ID is an identifier whereby data processing is uniquely identifiable. Hereinafter, data processing of a data processing ID:1 is also referred to as data processing 1. Other data processing is also referred to as data processing 2, data processing 3, data processing 4 and data processing 5, similarly.

Furthermore, priority degrees are set to five types of data processing. The priority degrees are described in numerical values. It is assumed that the larger the numerical value is, the higher the priority degree is.

In the present embodiment, as illustrated in FIG. 3, it is assumed that the priority degree of data processing of the data processing 1 is the highest, and the priority degree of data processing of the data processing 5 is the lowest.

In the present embodiment, the data processing execution device 100 executes data processing of a higher priority degree in preference to data processing of a lower priority degree. When data processing of a high priority degree occurs afterward during execution of data processing of a low priority degree, if contention on a hardware resource exists between the data processing of the low priority degree and the data processing of the high priority degree, the data processing execution device 100 interrupts execution of the data processing of the low priority degree, and executes firstly the data processing of the high priority degree on the hardware resource.

Each of 1A, 1B, 2A, . . . , 5C in FIG. 3 represents an engine.

1A and 1B are engines to execute the data processing 1.

2A, 2B and 2C are engines to execute the data processing 2.

3A, 3B and 3C are engines to execute the data processing 3.

4A and 4B are engines to execute the data processing 4.

5A, 5B and 5C are engines to execute the data processing 5.

An alphabet part of each engine corresponds to a degree of accuracy. “A” represents an engine with the highest degree of accuracy, and “C” represents an engine with the lowest degree of accuracy. As described, in the present embodiment, there exist two or more engines capable of executing the same data processing, and each of the two or more engines capable of executing the same data processing is different in degree of accuracy.

The two or more engines executing the same data processing are not necessarily realized by the same hardware resource. For example, the engine 1A may be realized by the FPGA 905, and the engine 1B may be realized by the CPU 901.

Further, there is a trade-off relation between the degree of accuracy and processing time. That is, even in a case wherein the same data processing is executed, the processing time is long by an engine with the high degree of accuracy, and the processing time is short by an engine with the low degree of accuracy. Therefore, when data processing of a high priority degree newly occurs due to an accidental event, it may occur that the engine of data processing of a low priority degree is switched to an engine with a low degree of accuracy, and the processing time of the data processing of the low priority degree is shortened.

Next, details of the function configuration of the data processing execution device 100 illustrated in FIG. 2 will be described based on the premise of above.

The data processing registration unit 101 accepts a data processing order. The data processing order is an order to direct execution of data processing. The data processing order includes a data processing ID, a priority degree and a deadline.

The deadline is a completion time limit of data processing.

The data processing registration unit 101 transfers the data processing order to the engine selection unit 102.

The engine selection unit 102 selects an engine made to execute data processing directed in the data processing order, from among a plurality of engines. The engine selection unit 102 refers to the engine list 110, and selects the engine. A detail of the engine list 110 will be described below.

The engine selected by the engine selection unit 102 that executes data processing is also called an execution engine. Further, the data processing executed by the execution engine is also called execution data processing. Additionally, data processing, for which an engine has been selected by the engine selection unit 102, and to which the engine has been assigned, but not executed yet, is also called assigned data processing.

When new data processing occurs while the execution engine executes execution data processing, the engine selection unit 102 may select an engine taking over the execution data processing as a takeover engine.

More specifically, when at least any of execution data processing, new data processing and assigned data processing is not completed by respective deadlines, by execution of execution data processing by the execution engine, the engine selection unit 102 selects an engine which is capable of completing the execution data processing, the new data processing and the assigned data processing by respective deadlines, as the takeover engine. For example, the engine selection unit 102 selects an engine with a degree of operational accuracy lower than that of the execution engine, which is capable of completing the execution data processing, the new data processing and the assigned data processing by respective deadlines, as the takeover engine. Further, when two or more engines like this exist, the engine selection unit 102 selects an engine with the highest degree of operational accuracy as the takeover engine.

The engine selection unit 102 examines switching of an engine assigned to the assigned data processing to another engine. Therefore, the engine selection unit 102 selects, as the takeover engine, an engine capable of completing the execution data processing, the new data processing and the assigned data processing by respective deadlines, in combination with switching of an engine assigned to the assigned data processing to another engine.

Further, when there are two or more pieces of execution data processing, the engine selection unit 102 selects, as the takeover engine, an engine capable of completing two or more pieces of execution data processing, new data processing and assigned data processing by respective deadlines.

The engine selection unit 102 examines switching to another engine for each execution data processing. Therefore, the engine selection unit 102 selects, as the takeover engine, an engine capable of completing execution data processing, new data processing, assigned data processing and other execution data processing by respective deadlines, in combination with switching to another engine for the other execution data processing and switching of an engine assigned to the assigned data processing to another engine.

Furthermore, the engine selection unit 102 selects the takeover engine so that data processing having the higher priority degree among the execution data processing, the new data processing and the assigned data processing is executed by an engine with the higher degree of operational accuracy.

The processing performed by the engine selection unit 102 corresponds to engine selection processing.

The engine execution management unit 103 outputs an execution order to a hardware resource to execute the engine selected by the engine selection unit 102.

Further, when it is necessary to interrupt execution data processing, the engine execution management unit 103 outputs an interruption order to an appropriate hardware resource. By outputting the interruption order, the engine execution management unit 103 makes the execution engine suspend execution of the execution data processing. Furthermore, when execution of the execution data processing is taken over to a takeover engine, the engine execution management unit 103 outputs an execution request to an appropriate hardware resource, and makes the takeover engine take over execution of the execution data processing.

Additionally, when it becomes possible to resume data processing in an interrupted state, the engine execution management unit 103 outputs a resumption request to an appropriate hardware resource.

Further, the engine execution management unit 103 receives a completion notice and a step completion notice from a hardware resource.

The engine execution management unit 103, together with the engine execution unit 104, corresponds to a control unit. Further, the processing performed by the engine execution management unit 103 corresponds to control processing.

In the engine execution unit 104, an execution unit is provided for each hardware resource.

In FIG. 2, for conciseness, only the CPU execution unit 1041 and the FPGA execution unit 1042 are illustrated.

The CPU execution unit 1041 is a function to execute an engine inside the CPU 901.

Further, the FPGA execution unit 1042 is a function to execute an engine inside the FPGA 905.

Furthermore, before a takeover engine is selected, the engine execution unit 104 generates an individual program code for an execution engine by converting a common program code (an engine implementation code 132 to be described below) commonly provided for engines capable of executing execution data processing. Then, the engine execution unit 104 makes the execution engine execute the execution data processing by using the individual program code for the execution engine generated.

Meanwhile, when the takeover engine is selected, the engine execution unit 104 generates an individual program code for the takeover engine by converting the common program code. Then, the engine execution unit 104 makes the takeover engine take over the execution data processing by using the individual program code for the takeover engine generated.

Together with the engine execution management unit 103, the engine execution unit 104 corresponds to a control unit. Further, the processing performed by the engine execution unit 104 corresponds to control processing.

The communication processing unit 105 transmits outside a result of data processing by an engine.

The communication processing unit 105 transmits the result of data processing to an actuator or a data processing execution device equivalent to the data processing execution device 100, for example.

The engine execution management data 120 includes the execution data processing list 121 and the execution standby data processing list 122.

The execution data processing list 121 is a list indicating data processing being executed.

The execution standby data processing list 122 is a list indicating a data processing waiting for execution.

Details of the execution data processing list 121 and the execution standby data processing list 122 are described below.

The engine software 130 includes the block function list 131 and the engine implementation code 132.

The engine implementation code 132 is a code (program) to implement each engine. The engine implementation code 132 is configured by a plurality of code blocks (hereinafter, also called simply blocks).

The block function list 131 indicates functions to realize processing of each block with respect to each block of the engine implementation code 132.

Details of the block function list 131 and the engine implementation code 132 will be described below.

The operation result storage memory 140 stores operation results by an engine.

Details of the operation result storage memory 140 will be described below.

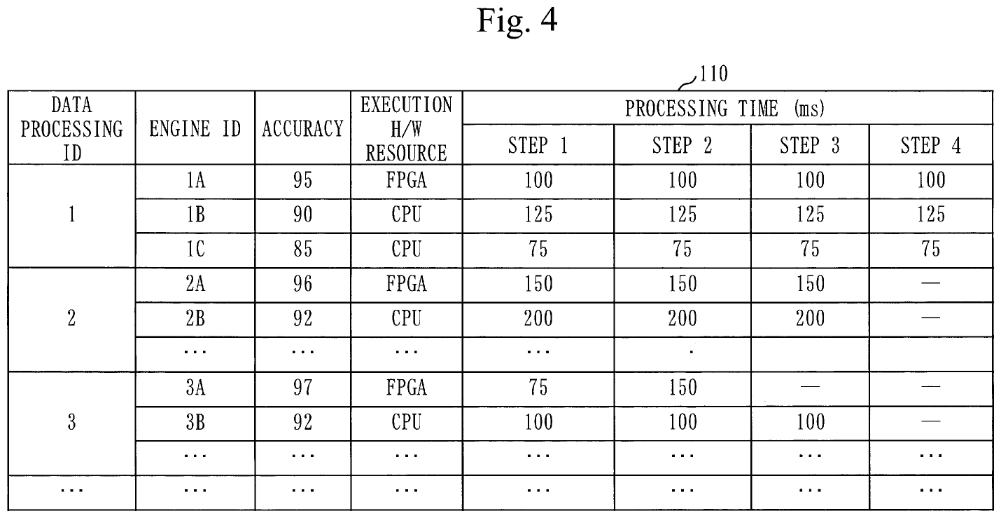

FIG. 4 illustrates an example of the engine list 110.

The engine list 110 indicates an engine ID of a selectable engine for each data processing ID. Further, a degree of accuracy, an execution hardware resource, a processing time for each step are indicated for each engine ID.

The degree of accuracy is represented by numerical values of 0 through 100. The larger the numerical value is, the higher the degree of accuracy is.

The execution hardware resource is a hardware resource necessary for execution of an engine.

The processing time is a time required for execution of each step. “-” means that no corresponding step exists. The step is partial data processing constituting data processing. The number of steps to be executed changes depending on the engine. For example, in the data processing 3, two steps are executed by an engine 3A, whereas three steps are executed by the engine 3B.

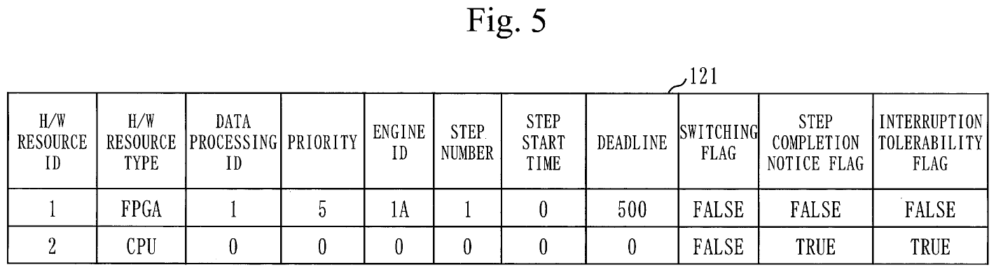

FIG. 5 illustrates an example of the execution data processing list 121.

In the execution data processing list 121, execution data processing is managed. That is, in the execution data processing list 121, data processing being executed by engines is managed.

In FIG. 5, the hardware resource ID is an identifier of a hardware resource.

A hardware resource type is a type of a hardware resource. In FIG. 5, in accordance with FIG. 2, only the FPGA 905 and the CPU 901 are illustrated.

The data processing ID is an identifier of data processing currently under execution by a hardware resource. When the value of the data processing ID is 0, it means that data processing is not executed by the pertinent hardware resource.

The priority degree is a priority degree of data processing currently under execution. When data processing is not executed, the value of the priority degree is 0.

The engine ID is an identifier of an engine executing data processing. When data processing is not executed, the value of the engine ID is 0.

A step number is an identifier of a step currently under execution. When data processing is not executed, the value of the step number is 0.

A step start time is a time when execution of a step currently under execution starts. In the present embodiment, the step start time is denoted by a count value (for example, a count value incremented every 1μ second).

A deadline is a time of a completion limit of data processing currently under execution. The deadline is also denoted by a count value.

A switching flag becomes TRUE when there exists a switching request of an engine for data processing currently under execution. When the switching flag becomes TRUE, switching processing of an engine is performed after completion of a step currently under execution.

A step completion notice flag becomes TRUE when the step completion notice is issued. The step completion notice is a message notifying the engine execution management unit 103 that execution of the step has been completed. When the step completion notice flag becomes TRUE, switching processing of an engine is performed.

An interruption tolerability flag indicates whether a hardware resource tolerates interruption of a step during execution. When the hardware resource tolerates interruption of a step during execution, TRUE is indicated in an interruption tolerability flag. In the FPGA 905, interruption of the step during execution is not tolerated; whereas, in the CPU 901, interruption of the step during execution is tolerated. Interruption of the step during execution is realized by using a pre-empting function on a task, by a real-time operating system (OS) and so on.

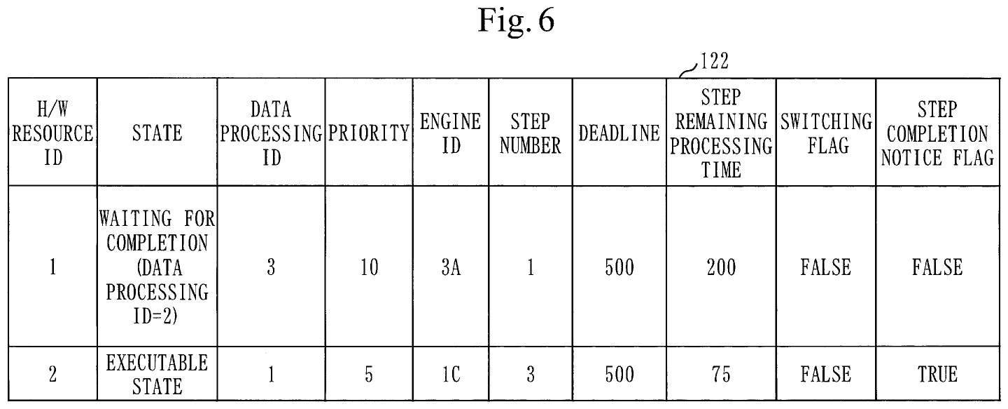

FIG. 6 illustrates an example of the execution standby data processing list 122.

In the execution standby data processing list 122, data processing waiting for execution is managed.

In FIG. 6, the hardware resource ID is an identifier of a hardware resource.

A state of either “waiting for step completion” or “executable state” is taken. “Waiting for step completion” is a state waiting for execution completion of a step of other data processing (in an example of FIG. 6, data processing ID2). A state where switching to a different engine occurs after completion of other data processing is “waiting for step completion”. “Executable state” is a state of waiting for execution completion of other data processing of a high priority degree.

A data processing ID is an identifier of data processing waiting for execution.

A priority degree is a priority degree of data processing waiting for execution.

An engine ID is an identifier of an engine scheduled to execute data processing waiting for execution.

A step number is an identifier of a step of data processing waiting for execution. That is, the step number is an identifier of a step waiting for execution.

A deadline is a time of a completion limit of the step waiting for execution. The deadline is also denoted by a count value.

A step remaining processing time is a remaining processing time of a step waiting for execution. When execution is interrupted during execution of a step, the step remaining processing time is used for obtaining a remaining processing time of the step waiting for execution. The step remaining processing time is also denoted by a count value.

A switching flag becomes TRUE when there exists a switching request of an engine regarding data processing waiting for execution. When the switching flag becomes TRUE, switching processing of an engine is performed after completion of the step waiting for execution.

A step completion notice flag becomes TRUE when the step completion notice is issued. When the step completion notice flag becomes TRUE, switching processing of the engine is performed.

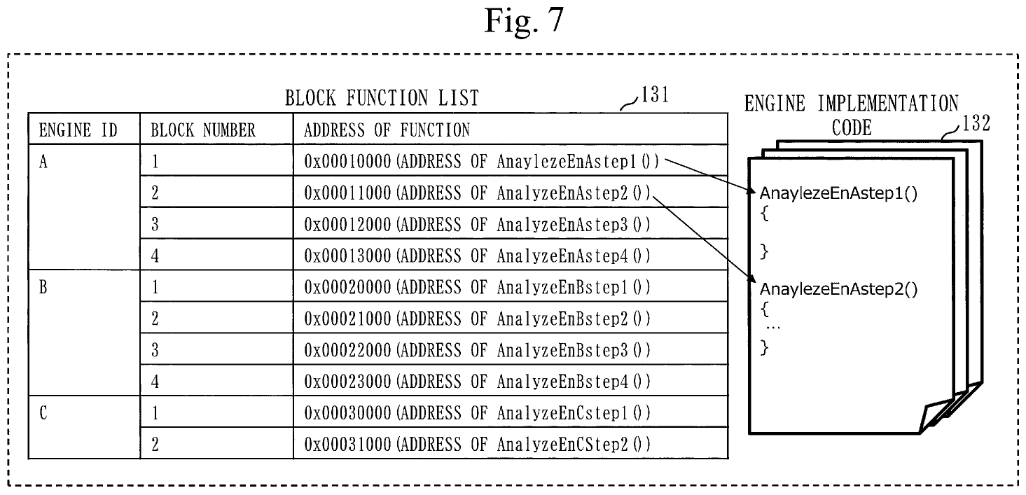

FIG. 7 illustrates an example of the block function list 131 and the engine implementation code 132.

The engine implementation code 132 is a code (program) to implement an engine. The engine implementation code 132 is configured by a plurality of code blocks. The engine implementation code 132 is a program code (common program code) provided commonly to two or more engines (for example, the engine 1A and the engine 1B) executing the same data processing. The engine execution management unit 103 converts the engine implementation code 132 into an individual program code for each engine (for example, for the engine 1A and for the engine 1B).

The block function list 131 is a list of a function to realize processing of each block of the engine implementation code 132.

In the block function list 131, an engine ID is an identifier of an engine.

A block number is an identifier of a block included in the engine implementation code 132.

An address of a function is an address of a function included in a block.

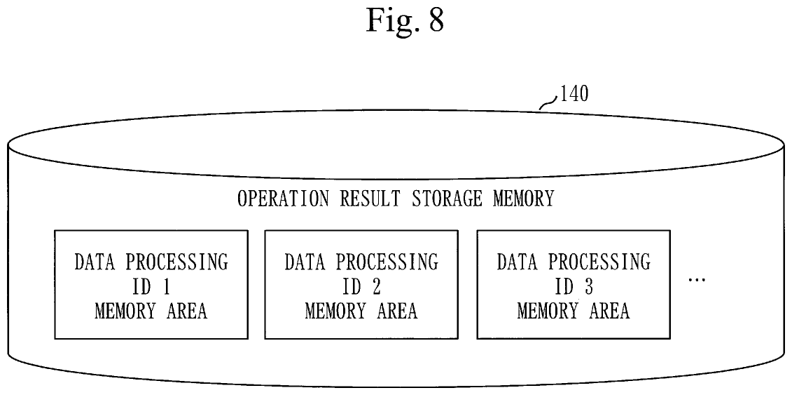

FIG. 8 illustrates an example of the operation result storage memory 140.

In the operation result storage memory 140, a dedicated memory area is secured for storing an operation result with respect to each data processing.

Even when an engine to execute data processing is switched during execution, by accessing a memory area of pertinent data processing by an engine after switching, it is possible to utilize an operation result of the engine before switching.

***Explanation of Operation***

Hereinafter, an example of operations of the data processing execution device 100 according to the present embodiment will be described.

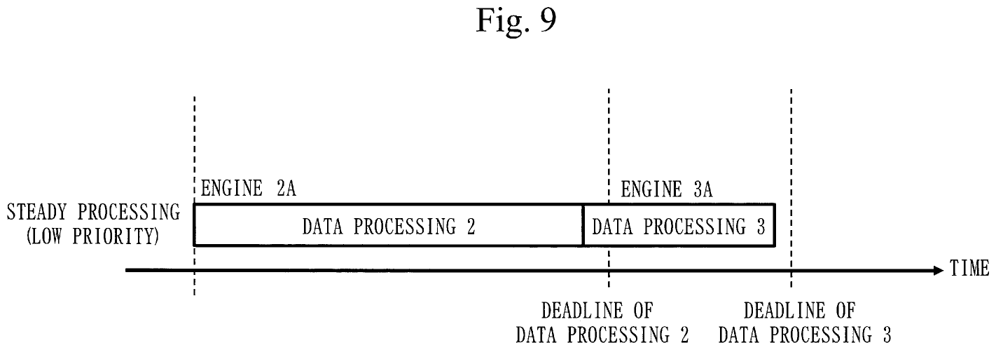

First, with reference to FIG. 9 through FIG. 14, it will be described processing to switch an engine for data processing of a low priority degree to an engine with a low degree of accuracy due to occurrence of data processing of a high priority degree.

FIG. 9 illustrates an execution schedule of the data processing 2 and the data processing 3.

The data processing 2 is assumed to be executed by an engine 2A. Further, the data processing 3 is assumed to be executed by the engine 3A.

It is possible to complete the data processing 2 and the data processing 3 by respective deadlines.

It is assumed that the engine 2A, the engine 3A, and the engine 1A and the engine 2B to be described below are all realized by the CPU 901. That is, the engine 2A, the engine 3A, the engine 1A and the engine 2B are not processed in parallel.

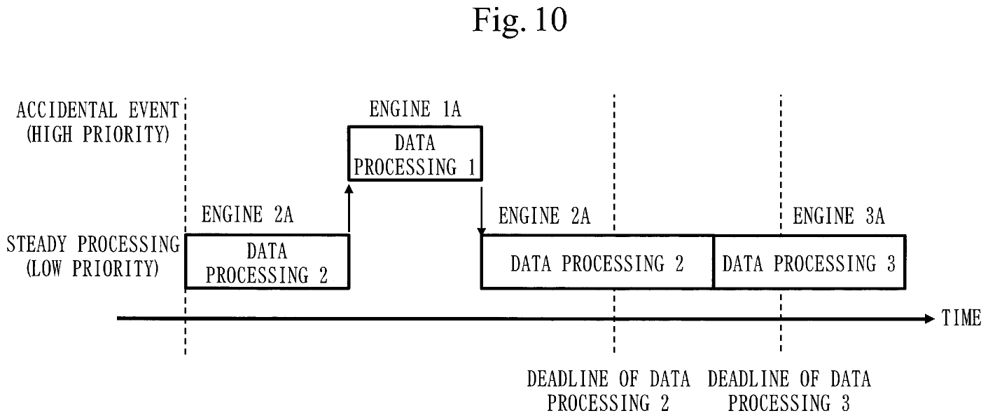

FIG. 10 illustrates that data processing 1 of a high priority degree being new data processing occurs due to an accidental event during execution of the data processing 2. Since the data processing 2 is being executed when the data processing 1 occurs, the data processing 2 corresponds to the execution data processing. Further, the engine 2A corresponds to the execution engine. The engine 3A is assigned to the data processing 3, but the data processing 3 is yet to be executed; hence, the data processing 3 corresponds to assigned data processing.

Although the data processing 2 is in the middle of execution, in order to prioritize the data processing 1, execution of the data processing 2 is interrupted. The data processing 1 is assumed to be executed by the engine 1A. When execution of the data processing 1 is completed, execution of the data processing 2 is resumed. Since the data processing 1 has been executed, if the rest of data processing 2 is executed by the engine 2A, the data processing 2 is not completed by a deadline of the data processing 2. Further, the data processing 3 is not completed by a deadline of the data processing 3.

Therefore, in the data processing execution device 100 according to the present embodiment, an engine of at least either the data processing 2 or the data processing 3 is switched to an engine with a low degree of accuracy to shorten a processing time.

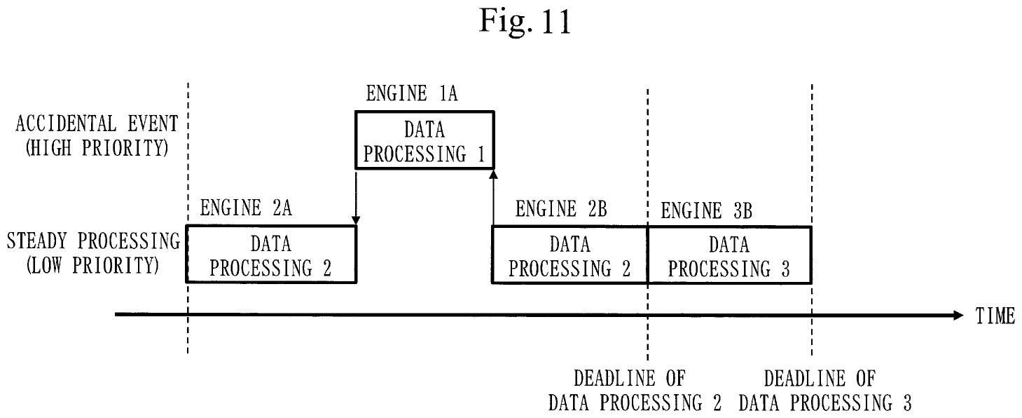

FIG. 11 illustrates an example of switching an engine for the data processing 2 to the engine 2B with a low degree of accuracy, and switching an engine for the data processing 3 to the engine 3B with a low degree of accuracy. The engine 2B is an engine to take over execution of the data processing 2 being the execution data processing from the engine 2A, and the engine 2B corresponds to the takeover engine.

Since the engine is switched to an engine with a low degree of accuracy, a processing time is shortened, and the data processing 2 and the data processing 3 are completed by the respective deadlines.

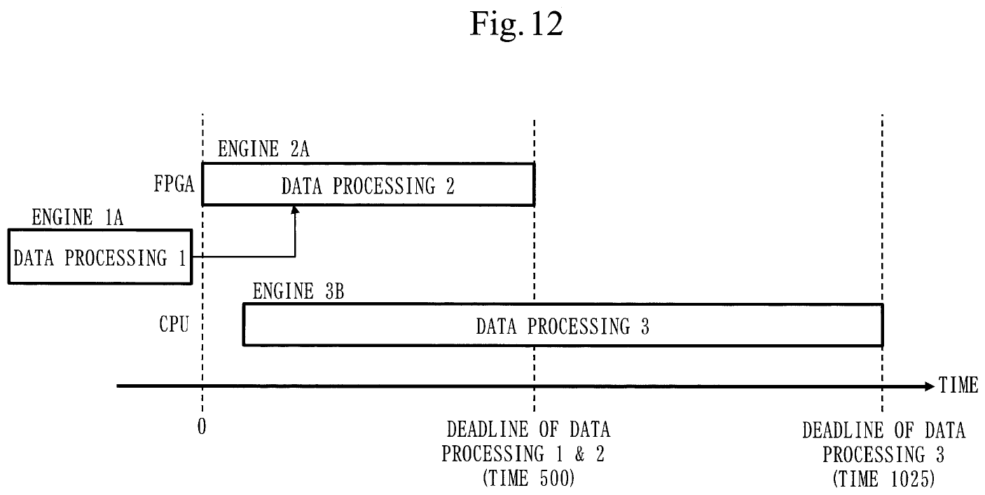

FIG. 12 illustrates an example where the CPU 901 and the FPGA 905 exist as hardware to realize an engine.

Hereinafter, the engine 1A and the engine 2A are assumed to be operated on the FPGA 905. Furthermore, the engine 2B, the engine 2C and the engine 3B are assumed to be operated by the CPU 901.

In FIG. 12, the data processing 2 is performed by the engine 2A on the FPGA 905, and the data processing 3 is performed by the engine 3B on the CPU 901. It is assumed that the data processing 1 newly occurs due to an accidental event. In the example of FIG. 12, each of the data processing 2 and the data processing 3 corresponds to the execution data processing. The data processing 1 corresponds to the new data processing. Further, each of the engine 2A and the engine 3B corresponds to the execution engine.

Both deadlines of the data processing 1 and the data processing 2 are a time 500. Further, a deadline of the data processing 3 is a time 1025. In order to complete the data processing 1 by the deadline, it is necessary to perform the data processing 1 by the engine 1A operated on the FPGA 905. Therefore, the data processing 1 and the data processing 2 compete with each other on the FPGA 905. Since the data processing 1 has a higher priority degree, it is not allowed to continue execution of the data processing 2 on the FPGA 905. When execution of the data processing 2 is resumed on the FPGA 905 after execution of the data processing 1 is completed on the FPGA 905, the data processing 2 is not completed by the deadline.

Therefore, the data processing execution device 100 searches for a combination of engines capable of completing the data processing 2 and the data processing 3 by the deadlines even when the data processing 1 is executed.

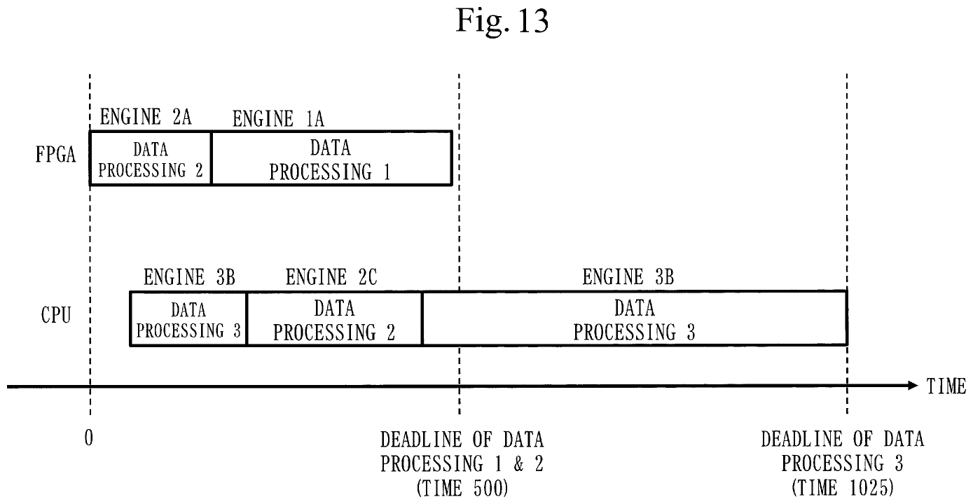

For example, as illustrated in FIG. 13, it is assumed that the data processing execution device 100 completes the data processing 2 and the data processing 3 by the deadlines by making the engine 2C execute the data processing 2, and the engine 3B execute the data processing 3. In the present example, the engine 2C corresponds to the takeover engine.

In this case, the data processing execution device 100 suspends execution of the data processing 2 on the FPGA 905, and makes the engine 1A execute the data processing 1 on the FPGA 905. While the engine 3B executes the data processing 3 on the CPU 901, the data processing 2 has a higher priority degree than the data processing 3. Therefore, the data processing execution device 100 suspends execution of the data processing 3 on the CPU 901, and makes the engine 2C take over execution of the data processing 2. Then, the data processing execution device 100 makes the engine 3B execute the rest of the data processing 3 after completion of the data processing 2.

By scheduling as described above, it is possible to complete the data processing 1, the data processing 2 and the data processing 3 by respective deadlines, as illustrated in FIG. 13.

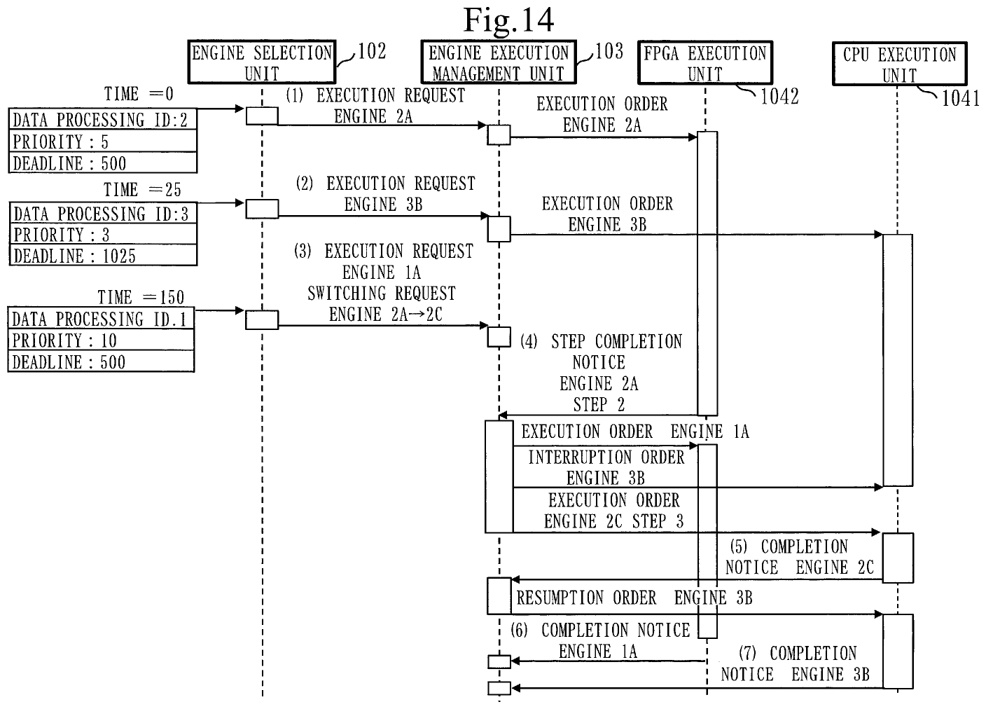

FIG. 14 illustrates a scheduling procedure illustrated in FIG. 12 and FIG. 13 in relation to operations of components of the data processing execution device 100.

When a data processing order occurs at time=0, and execution of the data processing 2 is instructed, the engine selection unit 102 selects an engine made to execute the data processing 2. In this case, the engine selection unit 102 selects the engine 2A. Details of an engine selection algorithm of the engine selection unit 102 will be described below. Then, the engine selection unit 102 requests the engine execution management unit 103 to execute the data processing 2 by the engine 2A (outputs an execution request).

Since the engine 2A operates on the FPGA 905, the engine execution management unit 103 requests the FPGA execution unit 1042 to execute the data processing 2 by the engine 2A (outputs an execution order). The FPGA execution unit 1042 is a function to execute an engine on the FPGA 905.

A data processing order occurs at time=25, and execution of the data processing 3 is instructed, the engine selection unit 102 selects an engine made to execute the data processing 3. In this case, the engine selection unit 102 selects the engine 3B. Then, the engine selection unit 102 requests the engine execution management unit 103 to execute the data processing 3 by the engine 3B (outputs an execution request).

Since the engine 3B operates on the CPU 901, the engine execution management unit 103 requests the CPU execution unit 1041 to execute the data processing 3 by the engine 3B (outputs an execution order). The CPU execution unit 1041 is a function to execute an engine on the CPU 901.

When a data processing order occurs at time=150, and execution of the data processing 1 is instructed, the engine selection unit 102 selects an engine made to execute the data processing 1. In this case, the engine selection unit 102 selects the engine 1A. As described by using FIG. 12 and FIG. 13, when the data processing 1 is executed on the FPGA 905, the data processing 2 is not completed by the deadline.

Therefore, the engine selection unit 102 searches for a combination of engines capable of completing the data processing 2 and the data processing 3 by the deadlines even when the data processing 1 is executed.

Engines selectable for the data processing 2 are the engine 2B and the engine 2C, and engines selectable for the data processing 3 are the engine 3B and the engine 3C.

First, the engine selection unit 102 determines whether both of the data processing 2 and the data processing 3 are completed by the deadlines when the engine 2B and the engine 3B are used. In this case, it is assumed that the data processing 2 is completed by the deadline, but the data processing 3 is not completed.

Next, the engine selection unit 102 determines whether both of the data processing 2 and the data processing 3 are completed by the deadlines when the engine 2B and the engine 3C are used. In this case, it is assumed that the data processing 2 is completed by the deadline, but the data processing 3 is not completed.

Next, the engine selection unit 102 determines whether both of the data processing 2 and the data processing 3 are completed by the deadlines when the engine 2C and the engine 3B are used. In this case, it is assumed that both of the data processing 2 and the data processing 3 are completed by the deadlines.

Therefore, the engine selection unit 102 decides switching of the engine for the data processing 2 to the engine 2C.

The engine selection unit 102 requests the engine execution management unit 103 to execute the data processing 1 by the engine 1A (outputs an execution request). Further, the engine selection unit 102 requests the engine execution management unit 103 to switch the engine for the data processing 2 from the engine 2A to the engine 2C (outputs a switching request).

Each data processing is configured by a plurality of steps. At the point of time=150, a step 2 of the data processing 2 is being executed on the FPGA 905, It is not allowed for the FPGA 905 to suspend data processing before a step is completed. Therefore, in order for the data processing 1 to be executed by the engine 1A, it is necessary to wait for completion of the step 2 of the data processing 2.

When execution of the step 2 of the data processing 2 is completed, the FPGA execution unit 1042 notifies the engine execution management unit 103 of completion of the step 2 (outputs a step completion notice).

Since the step 2 is completed, the engine execution management unit 103 requests the FPGA execution unit 1042 to execute the data processing 1 by the engine 1A (outputs an execution order).

Further, in order for the data processing 2 to be executed by the engine 2C, the engine execution management unit 103 requests the CPU execution unit 1041 to interrupt execution of the engine 3B (outputs an interruption order). It is possible to suspend an engine without waiting for completion of a step on the CPU 901.

Further, the engine execution management unit 103 requests the CPU execution unit 1041 to have the data processing 2 be executed by the engine 2C from the step 3 (outputs an execution order).

Thereafter, when the data processing 2 by the engine 2C is completed, the CPU execution unit 1041 notifies the engine execution management unit 103 of completion of the data processing 2 (outputs a completion notice).

Since the data processing 2 is completed, the engine execution management unit 103 requests the CPU execution unit 1041 to resume the data processing 3 by the engine 3B (outputs a resumption request).

When the data processing 1 by the engine 1A is completed, the FPGA execution unit 1042 notifies the engine execution management unit 103 of completion of the data processing 1 (outputs a completion notice).

When the data processing 3 by the engine 3B is completed, the CPU execution unit 1041 notifies the engine execution management unit 103 of completion of the data processing 3 (outputs a completion notice).

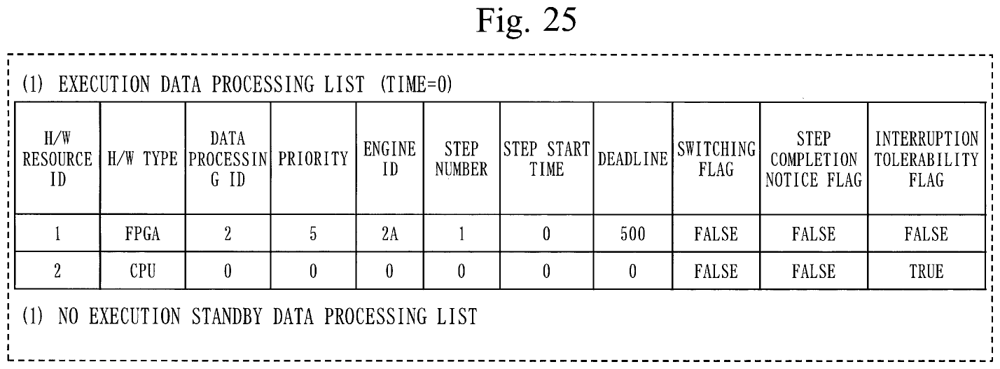

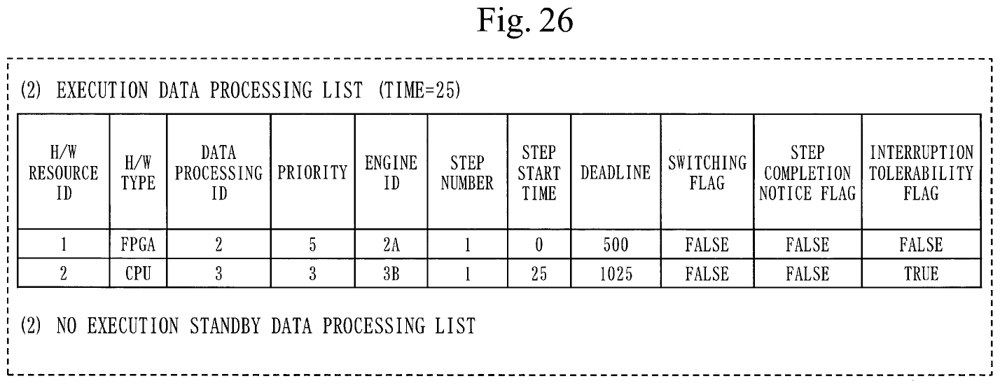

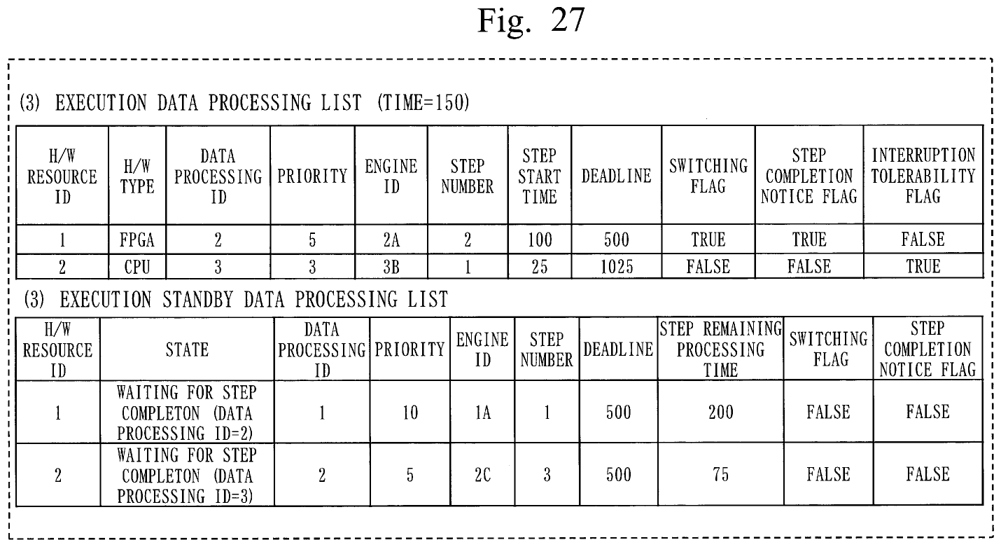

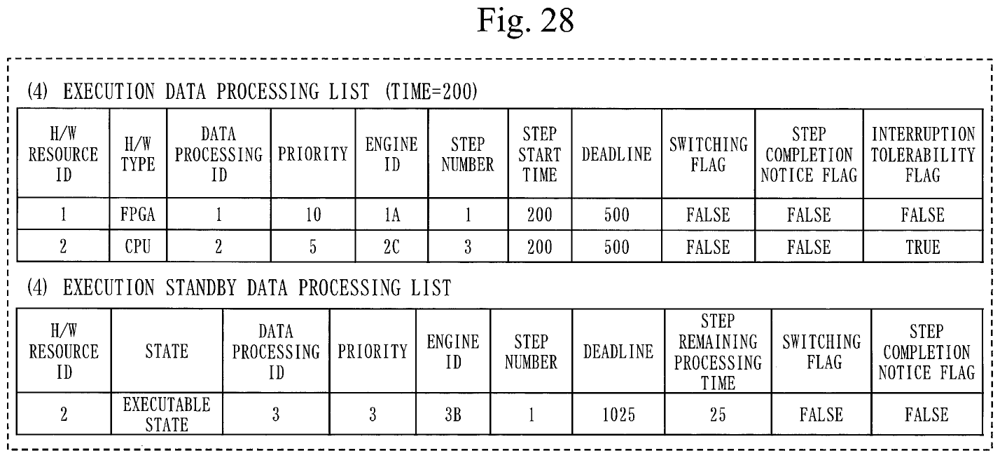

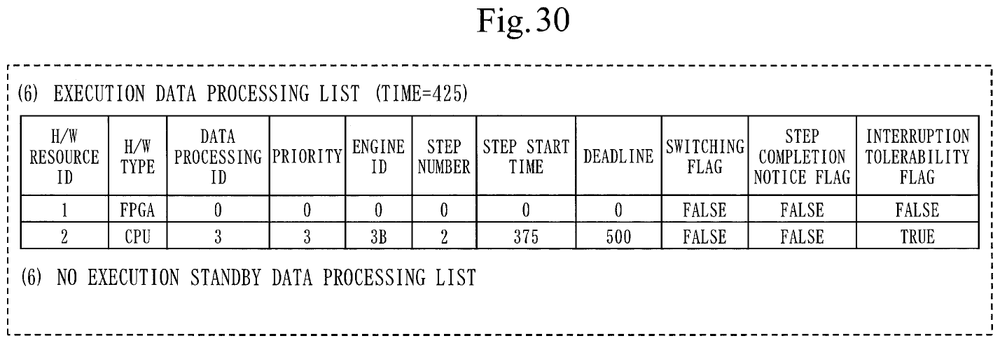

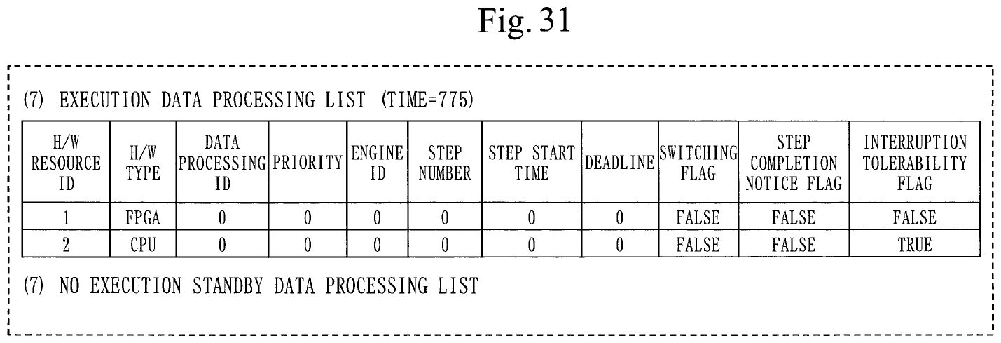

Further, FIG. 25 through FIG. 31 illustrate values of an execution data processing list and values of an execution standby data processing list at each timing of (1) through (7) in FIG. 14.

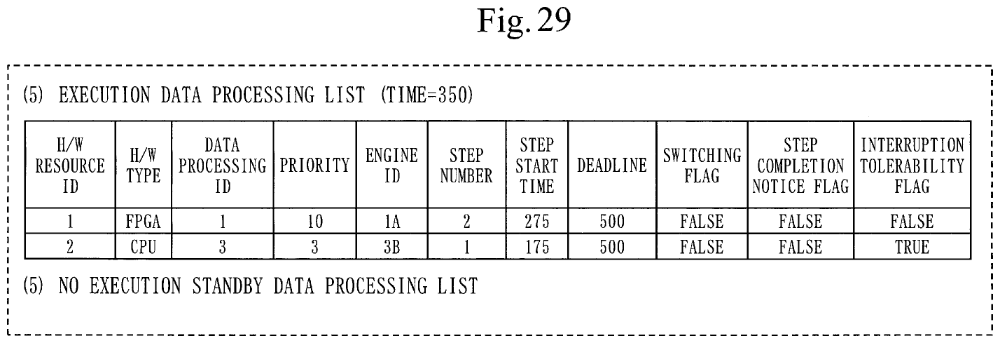

A pseudo step start time is set in “step start time” of “H/W resource ID:2” in FIG. 29. That is, the pseudo step start time is set so that a remaining time can be calculated from a current time (current time (350)−step 1 processing time (200)+step remaining processing time (25)=175).

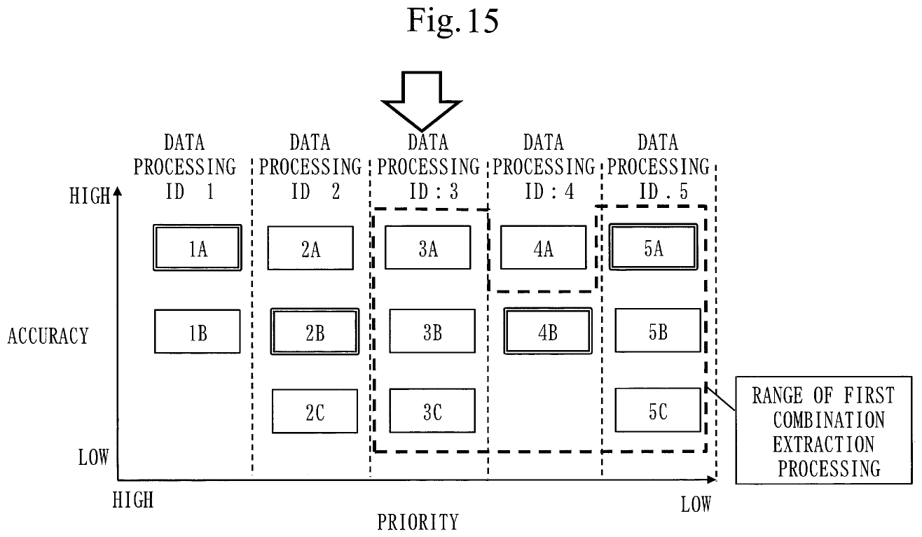

Next, with reference to FIG. 15 through FIG. 17, an overview of engine selection processing by the engine selection unit 102 will be described.

The engine selection unit 102 selects a combination of suitable engines based on a selection criterion as follows:

1) All of new data processing and existing data processing (execution data processing and assigned data processing) are completed by the respective deadlines.

2) An engine having a higher degree of operational accuracy is assigned to data processing having a higher priority degree.

FIG. 15 illustrates that the data processing 3 occurs in a state wherein engines are assigned to the data processing 1, the data processing 2, the data processing 4 and the data processing 5.

In FIG. 15, engines surrounded by double frames are engines assigned to data processing. That is, the engine 1A is assigned to the data processing 1. The engine 2B is assigned to the data processing 2. The engine 4B is assigned to the data processing 4. The engine 5A is assigned to the data processing 5.

A part surrounded by a broken line in FIG. 15 is a range of first combination extraction processing to be described below. Since it is found when the data processing 4 occurs that the data processing 4 is not completed by the deadline even if the engine 4A is used, the engine 4A is not included in the range of the first combination extraction processing.

When the data processing 3 occurs, the engine selection unit 102 selects a combination of engines each having the highest degree of accuracy, from among combinations of engines capable of completing the data processing 3, the data processing 4 and the data processing 5 by the respective deadlines.

Specifically, the engine selection unit 102 determines whether each of the data processing 3, the data processing 4 and the data processing 5 is completed by each deadline, by a combination of the engine 3A, the engine 4B and the engine 5A. When each of the data processing 3, the data processing 4 and the data processing 5 is completed by each deadline, the engine selection unit 102 selects the engine 3A as an engine to execute the data processing 3.

When each of the data processing 3, the data processing 4 and the data processing 5 is not completed by each deadline, the engine selection unit 102 determines whether each of the data processing 3, the data processing 4 and the data processing 5 is completed by each deadline, by switching an engine for the data processing 5 to the engine 5B.

When each of the data processing 3, the data processing 4 and the data processing 5 is completed by each deadline, the engine selection unit 102 decides selecting of the engine 3A as the engine to execute the data processing 3, and switching of the engine to execute the data processing 5 to the engine 5B.

When each of the data processing 3, the data processing 4 and the data processing 5 is not completed by each deadline, the engine selection unit 102 determines whether each of the data processing 3, the data processing 4 and the data processing 5 is completed by each deadline by switching the engine for the data processing 5 to the engine 5C.

When each of the data processing 3, the data processing 4 and the data processing 5 is completed by each deadline, the engine selection unit 102 decides selecting of the engine 3A as the engine to execute the data processing 3, and switching of the engine to execute the data processing 5 to the engine 5C.

When each of the data processing 3, the data processing 4 and the data processing 5 is not completed by each deadline, the engine selection unit 102 determines whether each of the data processing 3, the data processing 4 and the data processing 5 is completed by each deadline, by a combination of the engine 3B, the engine 4B and the engine 5A.

When each of the data processing 3, the data processing 4 and the data processing 5 is completed by each deadline, the engine selection unit 102 selects the engine 3B as the engine to execute the data processing 3.

When each of the data processing 3, the data processing 4 and the data processing 5 is not completed by each deadline, the engine selection unit 102 performs processing similar to that in the case of the engine 3A.

When each of the data processing 3, the data processing 4 and the data processing 5 is not completed by each deadline even by a combination of the engine 3B, the engine 4B and the engine 5C, the engine selection unit 102 determines whether each of the data processing 3, the data processing 4 and the data processing 5 is completed by each deadline, by a combination of the engine 3C, the engine 4B and the engine 5A.

When each of the data processing 3, the data processing 4 and the data processing 5 is completed by each deadline, the engine selection unit 102 selects the engine 3C as the engine to execute the data processing 3.

When each of the data processing 3, the data processing 4 and the data processing 5 is not completed by each deadline, the engine selection unit 102 performs processing similar to that in the case of the engine 3A and the engine 3B.

When each of the data processing 3, the data processing 4 and the data processing 5 is not completed by each deadline even by a combination of the engine 3C, the engine 4B and the engine 5C, the engine selection unit 102 performs second combination extraction processing.

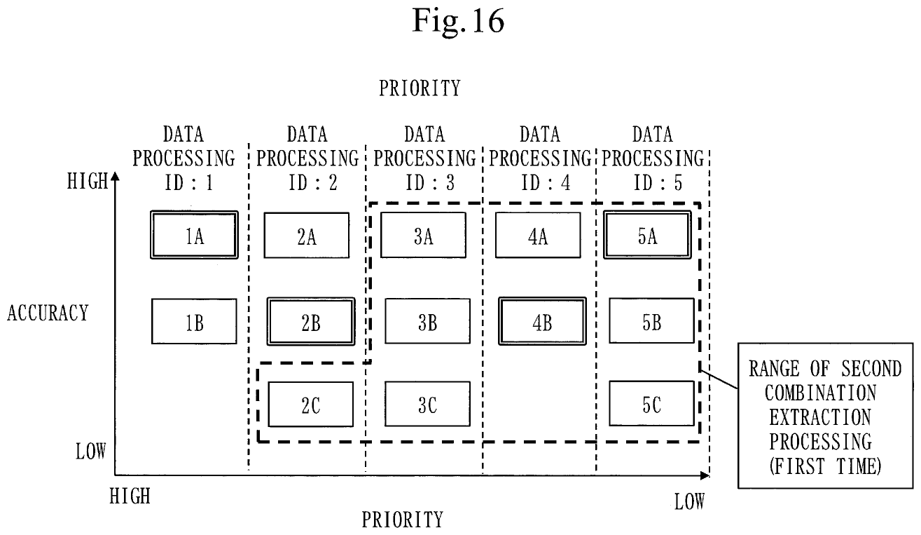

FIG. 16 illustrates a range of the second combination extraction processing (first time) by the engine selection unit 102.

When each of the data processing 3, the data processing 4 and the data processing 5 is not completed by each deadline even by the combination of the engine 3C, the engine 4B and the engine 5C, the engine selection unit 102 determines whether each of the data processing 2, the data processing 3, the data processing 4 and the data processing 5 is completed by each deadline when the engine for the data processing 2 is switched to the engine 2C.

That is, the engine selection unit 102 determines whether each of the data processing 2, the data processing 3, the data processing 4 and the data processing 5 is completed by each deadline, by a combination of the engine 2C, the engine 3A, the engine 4A and the engine 5A.

When each of the data processing 2, the data processing 3, the data processing 4 and the data processing 5 is completed by each deadline, the engine selection unit 102 decides selecting the engine 3A as the engine to execute the data processing 3, switching of the engine to execute the data processing 2 to the engine 2C, and switching of the engine to execute the data processing 4 to the engine 4A.

When each of the data processing 2, the data processing 3, the data processing 4 and the data processing 5 is not completed by each deadline, the engine selection unit 102 determines whether each of the data processing 2, the data processing 3, the data processing 4 and the data processing 5 is completed by each deadline by a combination of the engine 2C, the engine 3A, the engine 4A and the engine 5B.

When each of the data processing 2, the data processing 3, the data processing 4 and the data processing 5 is completed by each deadline, the engine selection unit 102 decides selecting of the engine 3A as the engine to execute the data processing 3, switching of the engine to execute the data processing 2 to the engine 2C, switching of the engine to execute the data processing 4 to the engine 4A, and switching of the engine to execute the data processing 5 to the engine 5B.

When each of the data processing 2, the data processing 3, the data processing 4 and the data processing 5 is not completed by each deadline, the engine selection unit 102 determines whether each of the data processing 2, the data processing 3, the data processing 4 and the data processing 5 is completed by each deadline by a combination of the engine 2C, the engine 3A, the engine 4A and the engine 5C.

When each of the data processing 2, the data processing 3, the data processing 4 and the data processing 5 is completed by each deadline, the engine selection unit 102 decides selecting of the engine 3A as the engine to execute the data processing 3, switching of the engine to execute the data processing 2 to the engine 2C, switching of the engine to execute the data processing 4 to the engine 4A, and switching of the engine to execute the data processing 5 to the engine 5C.

When each of the data processing 2, the data processing 3, the data processing 4 and the data processing 5 is not completed by each deadline, the engine selection unit 102 determines whether each of the data processing 2, the data processing 3, the data processing 4 and the data processing 5 is completed by each deadline, by a combination of the engine 2C, the engine 3A, the engine 4B and the engine 5A.

Hereinafter, the engine selection unit 102 sequentially examines combinations as follows:

Engine 2C, Engine 3A, Engine 4B and Engine 5B;

Engine 2C, Engine 3A, Engine 4B and Engine 5C;

Engine 2C, Engine 3B, Engine 4A and Engine 5A;

Engine 2C, Engine 3B, Engine 4A and Engine 5B;

Engine 2C, Engine 3B, Engine 4A and Engine 5C;

Engine 2C, Engine 3B, Engine 4B and Engine 5A;

Engine 2C, Engine 3B, Engine 4B and Engine 5B;

Engine 2C, Engine 3B, Engine 4B and Engine 5C;

Engine 2C, Engine 3C, Engine 4A and Engine 5A;

Engine 2C, Engine 3C, Engine 4A and Engine 5B;

Engine 2C, Engine 3C, Engine 4A and Engine 5C;

Engine 2C, Engine 3C, Engine 4B and Engine 5A;

Engine 2C, Engine 3C, Engine 4B and Engine 5B, and

Engine 2C, Engine 3C, Engine 4B and Engine 5C.

When each of the data processing 2, the data processing 3, the data processing 4 and the data processing 5 is not completed by each deadline by a combination of the engine 2C, the engine 3C, the engine 4B and the engine 5C, the engine selection unit 102 expands a range of the second combination extraction processing to an engine for the data processing 1.

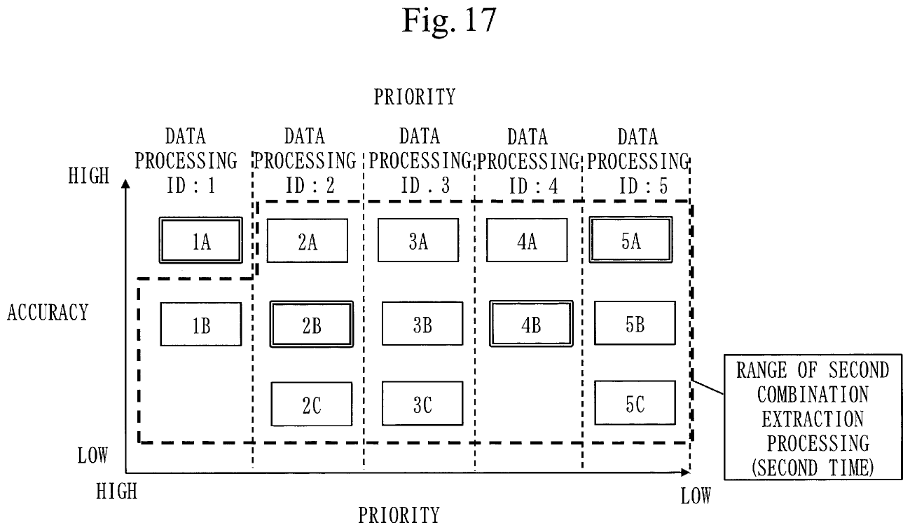

FIG. 17 illustrates a range of second combination extraction processing (second time) by the engine selection unit 102.

When each of the data processing 2, the data processing 3, the data processing 4 and the data processing 5 is not completed by each deadline by a combination of the engine 2C, the engine 3C, the engine 4B and the engine 5C, the engine selection unit 102 determines whether each of the data processing 1, the data processing 2, the data processing 3, the data processing 4 and the data processing 5 is completed by each deadline, in a case wherein the engine for the data processing 1 is switched to the engine 1B.

That is, the engine selection unit 102 determines whether each of the data processing 1, the data processing 2, the data processing 3, the data processing 4 and the data processing 5 is completed by each deadline by a combination of the engine 1B, the engine 2A, the engine 3A, the engine 4A and the engine 5A.

When each of the data processing 1, the data processing 2, the data processing 3, the data processing 4 and the data processing 5 is completed by each deadline, the engine selection unit 102 decides selecting of the engine 3A as the engine to execute the data processing 3, switching of the engine to execute the data processing 1 to the engine 1B, and switching of the engine to execute the data processing 4 to the engine 4A.

When each of the data processing 1, the data processing 2, the data processing 3, the data processing 4 and the data processing 5 is not completed by each deadline, the engine selection unit 102 determines whether each of the data processing 1, the data processing 2, the data processing 3, the data processing 4 and the data processing 5 is completed by each deadline, by a combination of the engine 1B, the engine 2A, the engine 3A, the engine 4A and the engine 5B.

When each of the data processing 1, the data processing 2, the data processing 3, the data processing 4 and the data processing 5 is completed by each deadline, the engine selection unit 102 decides selecting of the engine 3A as the engine to execute the data processing 3, switching of the engine to execute the data processing 1 to the engine 1B, switching of the engine to execute the data processing 4 to the engine 4A, and switching of the engine to execute the data processing 5 to the engine 5B.

When each of the data processing 1, the data processing 2, the data processing 3, the data processing 4 and the data processing 5 is not completed by each deadline, the engine selection unit 102 determines whether each of the data processing 1, the data processing 2, the data processing 3, the data processing 4 and the data processing 5 is completed by each deadline, by a combination of the engine 1B, the engine 2A, the engine 3A, the engine 4A and the engine 5C.

When each of the data processing 1, the data processing 2, the data processing 3, the data processing 4 and the data processing 5 is completed by each deadline, the engine selection unit 102 decides selecting of the engine 3A as the engine to execute the data processing 3, switching of the engine to execute the data processing 1 to the engine 1B, switching of the engine to execute the data processing 4 to the engine 4A, and switching of the engine to execute the data processing 5 to the engine 5C.

When each of the data processing 1, the data processing 2, the data processing 3, the data processing 4 and the data processing 5 is not completed by each deadline, the engine selection unit 102 determines whether each of the data processing 1, the data processing 2, the data processing 3, the data processing 4 and the data processing 5 is completed by each deadline, by a combination of the engine 1B, the engine 2A, the engine 3B, the engine 4A and the engine 5A.

Hereinafter, the engine selection unit 102 sequentially examines combinations as follows:

Engine 1B, Engine 2A, Engine 3A, Engine 4B and Engine 5A;

Engine 1B, Engine 2A, Engine 3A, Engine 4B and Engine 5B;

Engine 1B, Engine 2A, Engine 3A, Engine 4B and Engine 5C;

Engine 1B, Engine 2A, Engine 3B, Engine 4A and Engine 5A;

Engine 1B, Engine 2A, Engine 3B, Engine 4A and Engine 5B;

Engine 1B, Engine 2A, Engine 3B, Engine 4A and Engine 5C;

Engine 1B, Engine 2A, Engine 3B, Engine 4B and Engine 5A;

Engine 1B, Engine 2A, Engine 3B, Engine 4B and Engine 5B;

Engine 1B, Engine 2A, Engine 3B, Engine 4B and Engine 5C;

Engine 1B, Engine 2A, Engine 3C, Engine 4A and Engine 5A;

Engine 1B, Engine 2A, Engine 3C, Engine 4A and Engine 5B;

Engine 1B, Engine 2A, Engine 3C, Engine 4A and Engine 5C;

Engine 1B, Engine 2A, Engine 3C, Engine 4B and Engine 5A;

Engine 1B, Engine 2A, Engine 3C, Engine 4B and Engine 5B;

Engine 1B, Engine 2A, Engine 3C, Engine 4B and Engine 5C;

Engine 1B, Engine 2B, Engine 3A, Engine 4A and Engine 5A;

Engine 1B, Engine 2B, Engine 3A, Engine 4A and Engine 5B;

Engine 1B, Engine 2B, Engine 3A, Engine 4A and Engine 5C;

Engine 1B, Engine 2B, Engine 3A, Engine 4B and Engine 5A;

Engine 1B, Engine 2B, Engine 3A, Engine 4B and Engine 5B;

Engine 1B, Engine 2B, Engine 3A, Engine 4B and Engine 5C;

Engine 1B, Engine 2B, Engine 3B, Engine 4A and Engine 5A;

Engine 1B, Engine 2B, Engine 3B, Engine 4A and Engine 5B;

Engine 1B, Engine 2B, Engine 3B, Engine 4A and Engine 5C;

Engine 1B, Engine 2B, Engine 3B, Engine 4B and Engine 5A;

Engine 1B, Engine 2B, Engine 3B, Engine 4B and Engine 5B;

Engine 1B, Engine 2B, Engine 3B, Engine 4B and Engine 5C;

Engine 1B, Engine 2B, Engine 3C, Engine 4A and Engine 5A;

Engine 1B, Engine 2B, Engine 3C, Engine 4A and Engine 5B;

Engine 1B, Engine 2B, Engine 3C, Engine 4A and Engine 5C;

Engine 1B, Engine 2B, Engine 3C, Engine 4B and Engine 5A;

Engine 1B, Engine 2B, Engine 3C, Engine 4B and Engine 5B;

Engine 1B, Engine 2B, Engine 3C, Engine 4B and Engine 5C;

Engine 1B, Engine 2C, Engine 3A, Engine 4A and Engine 5A;

Engine 1B, Engine 2C, Engine 3A, Engine 4A and Engine 5B;

Engine 1B, Engine 2C, Engine 3A, Engine 4A and Engine 5C;

Engine 1B, Engine 2C, Engine 3A, Engine 4B and Engine 5A;

Engine 1B, Engine 2C, Engine 3A, Engine 4B and Engine 5B;

Engine 1B, Engine 2C, Engine 3A, Engine 4B and Engine 5C;

Engine 1B, Engine 2C, Engine 3B, Engine 4A and Engine 5A;

Engine 1B, Engine 2C, Engine 3B, Engine 4A and Engine 5B;

Engine 1B, Engine 2C, Engine 3B, Engine 4A and Engine 5C;

Engine 1B, Engine 2C, Engine 3B, Engine 4B and Engine 5A;

Engine 1B, Engine 2C, Engine 3B, Engine 4B and Engine 5B;

Engine 1B, Engine 2C, Engine 3B, Engine 4B and Engine 5C;

Engine 1B, Engine 2C, Engine 3C, Engine 4A and Engine 5A;

Engine 1B, Engine 2C, Engine 3C, Engine 4A and Engine 5B;

Engine 1B, Engine 2C, Engine 3C, Engine 4A and Engine 5C;

Engine 1B, Engine 2C, Engine 3C, Engine 4B and Engine 5A;

Engine 1B, Engine 2C, Engine 3C, Engine 4B and Engine 5B, and

Engine 1B, Engine 2C, Engine 3C, Engine 4B and Engine 5C.

When a suitable combination of engines is not obtained even with the procedure mentioned above, the engine selection unit 102 performs predetermined error processing.

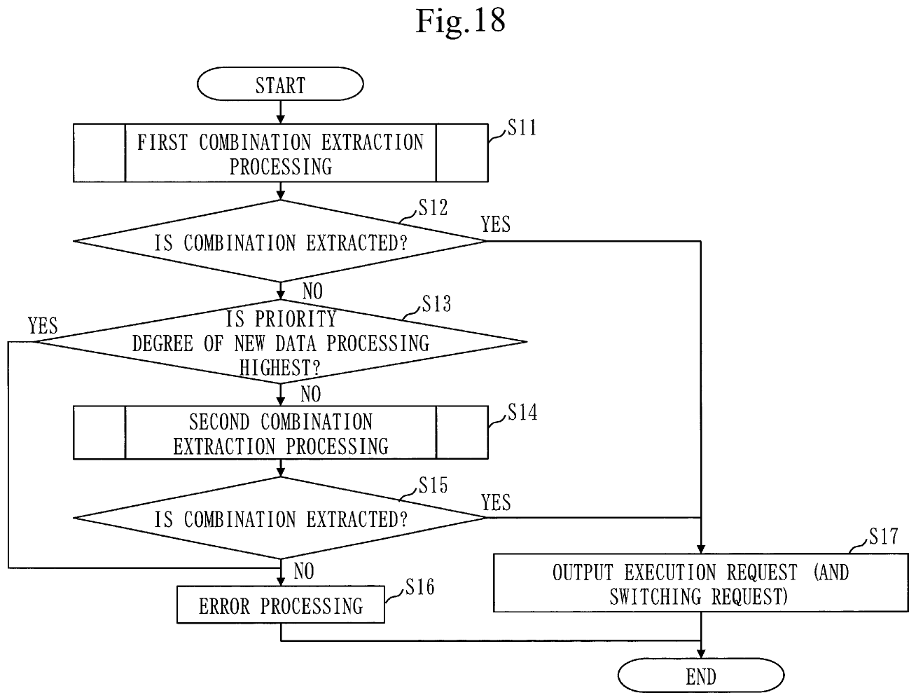

Next, an example of operations of the engine selection unit 102 will be described using FIG. 18 through FIG. 20.

FIG. 18 illustrates an overall operation flow of the engine selection unit 102.

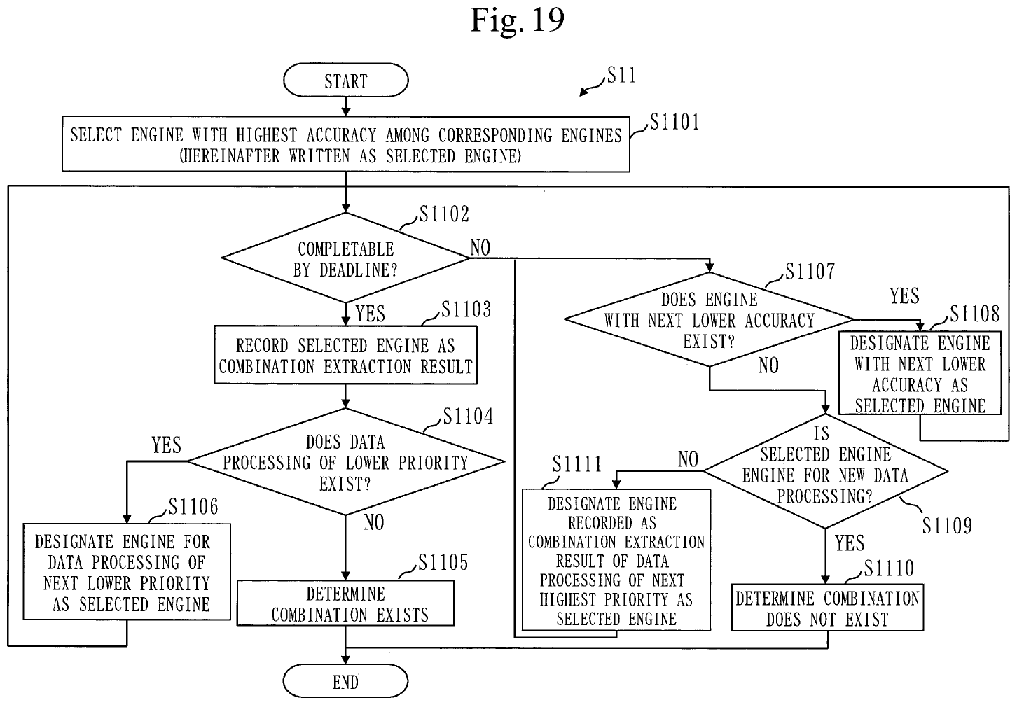

FIG. 19 illustrates a detail of “first combination extraction processing” (step S11) illustrated in FIG. 18.

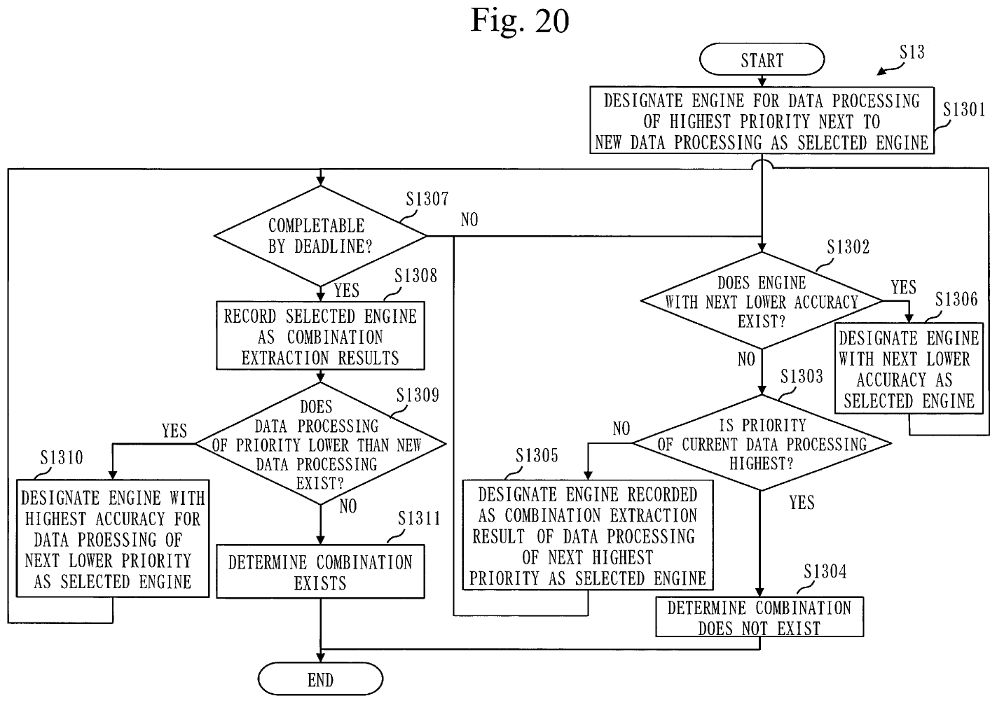

FIG. 20 illustrates a detail of “second combination extraction processing” (step S14) illustrated in FIG. 18.

When new data processing (for example, the data processing 3 illustrated in FIG. 15) occurs, the operation flow in FIG. 18 starts.

In step S11, the engine selection unit 102 performs the first combination extraction processing.

A detail of the first combination processing will be described with reference to FIG. 19.

Next, in step S12, the engine selection unit 102 determines whether a combination is extracted by the first combination extraction processing.

When the combination is extracted (YES in step S12), the processing proceeds to step S17.

On the other hand, when the combination is not extracted (NO in step S12), the engine selection unit 102 determines whether a priority degree of the new data processing is the highest (step S13). That is, the engine selection unit 102 determines whether the priority degree of the new data processing is higher than a priority degree of data processing whereto an engine has been already assigned.

When the priority degree of the new data processing is the highest (YES in step S13), the processing proceeds to step S16 since the second combination extraction processing cannot be performed.

Meanwhile, when the priority degree of the new data processing is not the highest priority degree (NO in step S13), the processing proceeds to step S14.

In step S14, the engine selection unit 102 performs the second combination extraction processing.

A detail of the second combination processing will be described with reference to FIG. 20.

Next, in step S15, the engine selection unit 102 determines whether a combination is extracted by the second combination extraction processing.

When the combination is extracted (YES in step S15), the processing proceeds to step S17.

Meanwhile, when the combination is not extracted (NO in step S15), the processing proceeds to step S16.

In step S16, the engine selection unit 102 performs predetermined error processing.

For example, as the error processing, the engine selection unit 102 reports an error, and suspends the data processing execution device 100 safely.

In step S17, the engine selection unit 102 outputs an execution request.

As illustrated in FIG. 14, it may be applicable for the engine selection unit 102 to output only an execution request in response to a situation, or to output an execution request and a switching request.

Next, the detail of the first combination extraction processing will be described with reference to FIG. 19.

In step S1101, the engine selection unit 102 selects an engine with the highest degree of accuracy from among engines corresponding to the new data processing.

The engine selection unit 102 refers to the engine list 110, and selects the engine with the highest degree of accuracy corresponding to the new data processing.

The engine selected in step S1101 is called a selected engine.

Next, in step S1102, when the new data processing is performed by using a selected engine, the engine selection unit 102 determines whether the new data processing is completed by a deadline of the new data processing.

When the new data processing is completed by the deadline of the new data processing (YES in step S1102), the processing proceeds to step S1103.

Meanwhile, when the new data processing is not completed by the deadline of the new data processing (NO in step S1102), the processing proceeds to step S1107.

In step S1103, the engine selection unit 102 records the selected engine as a combination extraction result in a storage area determined beforehand.

In step S1104, the engine selection unit 102 determines whether there exists data processing of a priority degree lower than that of the new data processing in data processing whereto engines have been already assigned.

When there exists the data processing of the priority degree lower than that of the new data processing (YES in step S1104), the engine selection unit 102 designates an engine for data processing of the next lower priority degree as a selected engine, in step S1106.

Then, the engine selection unit 102 performs processing of step S1102 and after step S1102, for the data processing of the next lower priority degree.

Meanwhile, when data processing of a priority degree lower than that of the new data processing does not exist (NO in step S1104), in step S1105, the engine selection unit 102 determines that a suitable combination of engines exists.

As a result, the engine selection unit 102 outputs an execution request (and a switching request) based on an extraction result recorded in step S1103, in step S17 in FIG. 18.

When the new data processing is not completed by the deadline of the new data processing (NO in step S1102), in step S1107, the engine selection unit 102 determines whether there exists for the new data processing, an engine with lower degree of accuracy next to the selected engine.

When there exists the engine with the next lower degree of accuracy (YES in step S1107), the engine selection unit 102 designates the engine with the next lower degree of accuracy as a new selected engine, in step S1108.

Then, the engine selection unit 102 performs processing of step S1102 and after step S1102 by using the new selected engine.

When the engine with the next lower degree of accuracy does not exist (NO in step S1107), the engine selection unit 102 determines whether a present selected engine is an engine for the new data processing, in step S1109.

When the present selected engine is the engine for the new data processing (YES in step S1109), the engine selection unit 102 determines that a suitable combination of engines does not exist, in step S1110.

Meanwhile, when the present selected engine is not the engine for the new data processing (NO in step S1109), in step S1111, the engine selection unit 102 designates as a selected engine, an engine recorded as a combination extraction result of data processing of a next highest priority degree, and performs processing of step S1107 and after step S1107. In the processing of step S1107 and after the step 1107, the engine selection unit 102 attempts to extract a combination of engines capable of completing the data processing of the next highest priority degree and the data processing of a priority degree below the next highest priority degree, by deadlines, in a state wherein a degree of accuracy of the selected engine for the data processing of the next highest priority degree is lowered. As described above, by repeating the steps described above until it becomes YES in the S1109, the engine selection unit 102 assigns an engine with the higher degree of accuracy to data processing of the higher priority degree, and extracts a combination of engines to attain completion by deadlines in the range of the combination extraction processing described in FIG. 15.

Next, with reference to FIG. 20, the detail of the second combination extraction processing will be described.

In step S1301, the engine selection unit 102 designates, as a selected engine, an engine executing data processing of the highest priority degree next to the new data processing.

Next, in step S1302, the engine selection unit 102 determines whether there exists an engine with a lower degree of accuracy next to the selected engine.

When there exists the engine with the lower degree of accuracy next to the selected engine, the processing proceeds to step S1306; whereas, when the engine with the lower degree of accuracy next to the selected engine does not exist, the processing proceeds to step S1303.

In step S1303, the engine selection unit 102 determines whether the priority degree of the new data processing is the highest.

When the priority degree of the new data processing is the highest, the processing proceeds to step S1304.

Meanwhile, when the priority degree of the new data processing is not the highest priority degree, the processing proceeds to step S1305.

In step S1304, the engine selection unit 102 determines that a suitable combination of engines does not exist.

In step S1305, the engine selection unit 102 designates an engine recorded as a combination extraction result of data processing of the next highest priority degree, as a selected engine, and performs the processing of step S1302 and after step S1302. In the processing of step S1302 and after step S1302, the engine selection unit 102 attempts to extract a combination of engines capable of completing the data processing of the next highest priority degree and data processing of a priority degree below the next highest priority degree, by deadlines, in a state wherein a degree of accuracy of the selected engine for the data processing of the next highest priority degree is lowered.

When a record of the extraction result does not exist, the engine selection unit 102 designates the present selected engine as the selected engine again.

In step S1306, the engine selection unit 102 designates the engine with the next lower degree of accuracy as a new selected engine.

Then, the engine selection unit 102 performs processing of step S1307 and after step S1307 by using the new selected engine.

In step S1307, the engine selection unit 102 determines whether it is possible to complete the new data processing by a deadline by the present selected engine.

When the new data processing is completed by the deadline, the processing proceeds to step S1308. Meanwhile, when the new data processing is not completed by the deadline, the processing proceeds to step S1302.

In step S1308, the engine selection unit 102 records the selected engine as a combination extraction result in a storage area determined beforehand.

Next, in step S1309, the engine selection unit 102 determines whether there exists data processing of a priority degree lower than that of the new data processing.

When there exists the data processing of the priority degree lower than that of the new data processing, the processing proceeds to step S1310. Meanwhile, when the data processing of the priority degree lower than that of the new data processing does not exist, the processing proceeds to step S1311.

In step S1310, the engine selection unit 102 designates an engine with the highest degree of accuracy for the data processing of the next lower priority degree, as a selected engine. Then, the engine selection unit 102 performs processing of step S1307 and after step S1307 with respect to the data processing of the next lower priority degree and the new selected engine.

In step S1311, the engine selection unit 102 determines that a suitable combination of engines exists.

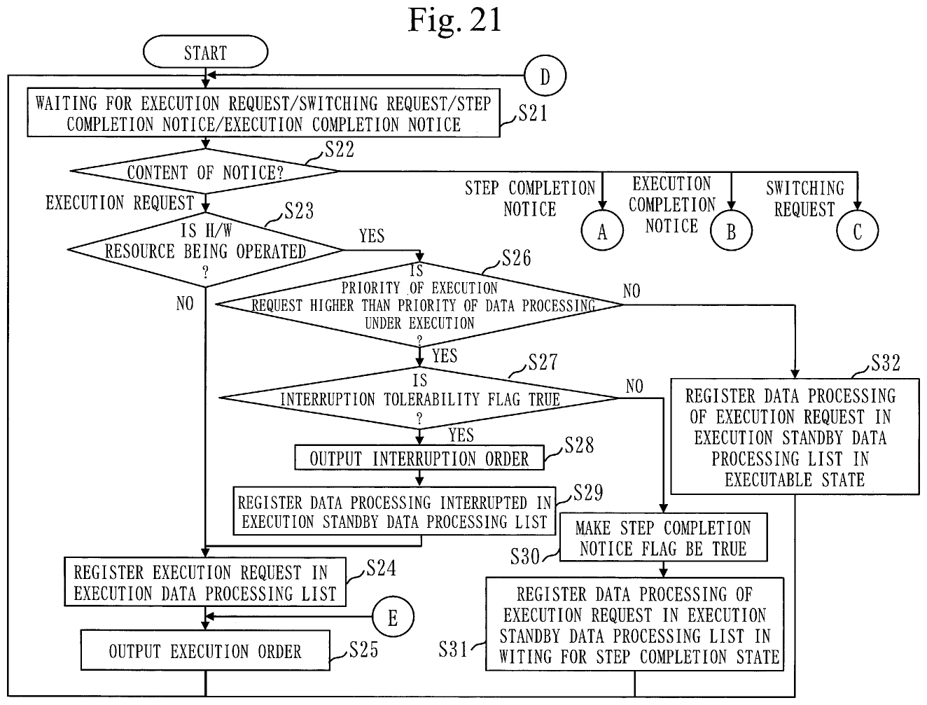

Next, with reference to FIG. 21 through FIG. 23, an example of operations of the engine execution management unit 103 according to the present embodiment will be described.

In step S21, the engine execution management unit 103 waits for reception of any of an execution request, a switching request, a step completion notice and an execution completion notice.

When any of the execution request, the switching request, the step completion notice and the execution completion notice is received, the engine execution management unit 103 determines which of the execution request, the switching request, the step completion notice and the execution completion notice is received.

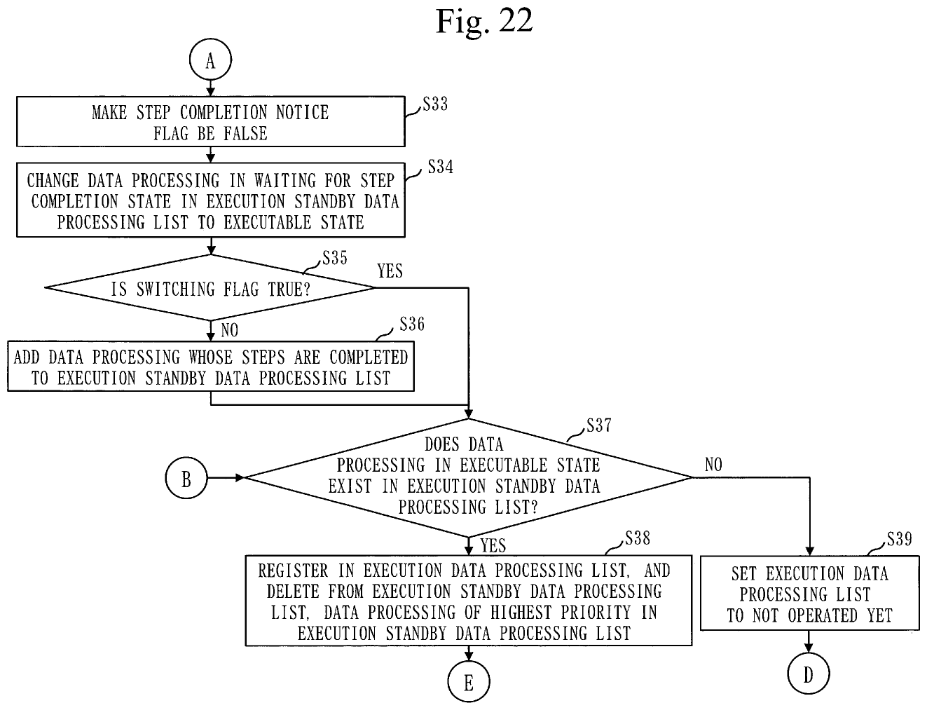

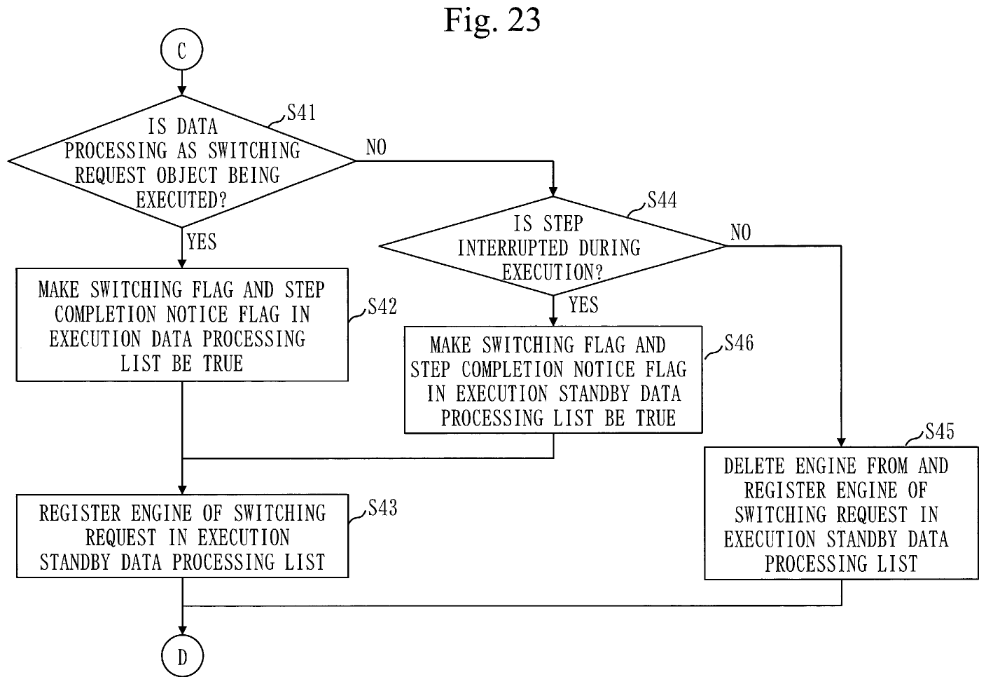

When the execution request is received, the processing proceeds to step S23. When the step completion notice is received, the processing proceeds to step S33 in FIG. 22. When the execution completion notice is received, the processing proceeds to step S37 in FIG. 22. When the switching request is received, the processing proceeds to step S41 in FIG. 23.

In step S23, the engine execution management unit 103 determines whether a hardware resource to realize an engine for which execution is requested by an execution request is currently operating.

When the hardware resource is currently operating, the processing proceeds to step S26. Meanwhile, the hardware resource is not currently operating, the processing proceeds to step S24.

In step S24, the engine execution management unit 103 registers the execution request in the execution data processing list 121.

Next, in step S25, the engine execution management unit 103 outputs an execution order to the engine execution unit 104.

In step S26, it is determined whether a priority degree of data processing indicated in the execution request is higher than a priority degree of data processing being executed by the hardware resource determined to be operating in step S23.

When the priority degree of the data processing indicated in the execution request is higher, the processing proceeds to step S27. Meanwhile, when the priority degree of the data processing indicated in the execution request is not higher, the processing proceeds to step S32.

In step S27, the engine execution management unit 103 determines whether an interruption tolerability flag of a pertinent hardware resource in the execution data processing list 121 is TRUE.

When the interruption tolerability flag is TRUE, the processing proceeds to step S28.

Meanwhile, when the interruption tolerability flag is FALSE, the processing proceeds to step S30.

In step S28, the engine execution management unit 103 outputs an interruption order to the engine execution unit 104.

Next, in step S29, the engine execution management unit 103 registers data processing being interrupted, that is, data processing being an object of the interruption order in step S28, in the execution standby data processing list 122.

In step S30, the engine execution management unit 103 makes a step completion notice flag be TRUE of a pertinent hardware resource in the execution data processing list 121.

Next, in step S31, the engine execution management unit 103 registers the data processing indicated in the execution request, as “waiting for step completion”, in the execution standby data processing list 122.

In step S32, the engine execution management unit 103 registers the data processing indicated in the execution request as “executable state”, in the execution standby data processing list 122.

As a result of determination in step S22 in FIG. 21, when it is found that a step completion notice has been received, the engine execution management unit 103 makes a step completion notice flag be FALSE in the execution data processing list 121 with respect to data processing whose steps have been completed, in step S33 in FIG. 22.

Next, in step S34, the engine execution management unit 103 makes data processing in a state of the “waiting for step completion” be in the “executable state”, in the execution standby data processing list 122, with respect to data processing whose steps have been completed.

Next, in step S35, the engine execution management unit 103 determines whether a switching flag is TRUE in the execution data processing list 121 with respect to the data processing whose steps have been completed.

When the switching flag is TRUE, the processing proceeds to step S37.

When the switching flag is FALSE, the processing proceeds to step S36.

In step S36, the engine execution management unit 103 adds the data processing whose steps have been completed to the execution standby data processing list 122.

In step S37, the engine execution management unit 103 determines whether data processing in the “executable state” exists in the execution standby data processing list 122.

When data processing in the “executable state” exists, the processing proceeds to step S38.

Meanwhile, when data processing in the “executable state” does not exist, the processing proceeds to step S39.

In step S38, the engine execution management unit 103 registers data processing of a highest priority degree in the execution standby data processing list 122, in the execution data processing list 121, and deletes the said data processing from the execution standby data processing list 122.

Then, the processing proceeds to step S25 in FIG. 21.

In step S39, the engine execution management unit 103 sets the execution data processing list 121 to “not operated yet”. “Not operated yet” means that data processing is not executed yet in the said hardware resource. Specifically, the engine execution management unit 103 performs processing of making a data processing ID, etc. be 0 in the execution data processing list 121, as defined in the paragraph 0042.

Then, the processing proceeds to step S21 in FIG. 21.

As a result of determination of step S22 in FIG. 21, when it is found that a switching request has been received, the engine execution management unit 103 determines whether data processing being an object of the switching request is being executed, in step S41 in FIG. 23.

When the data processing being the object of the switching request is being executed, the processing proceeds to step S42.

Meanwhile, when the data processing being the object of the switching request is not being executed, the processing proceeds to step S44.

In step S42, the engine execution management unit 103 makes a switching flag and a step completion notice flag be TRUE of data processing being the object, in the execution data processing list 121.

Next, in step S43, the engine execution management unit 103 registers an engine indicated in the switching request in the execution standby data processing list 122, in a row of a pertinent hardware list.

Then, the processing proceeds to step S21 in FIG. 21.

In step S44, the engine execution management unit 103 determines whether data processing being the object of the switching request is in an interrupted state during execution of steps.

When the data processing being the object of the switching request is in the interrupted state during execution of the steps, the processing proceeds to step S46.

Meanwhile, when the data processing being the object of the switching request is not in the interrupted state during execution of the steps, the processing proceeds to step S45.

In step S46, the engine execution management unit 103 makes a switching flag and a step completion notice flag be TRUE of the data processing being interrupted during execution of the steps, in the execution standby data processing list 122.

In step S45, the engine execution management unit 103 deletes an engine of the data processing being the object of the switching request from the execution standby data processing list 122, and registers an engine indicated in the switching request in the execution standby data processing list 122.

Then, the processing proceeds to step S21 in FIG. 21.

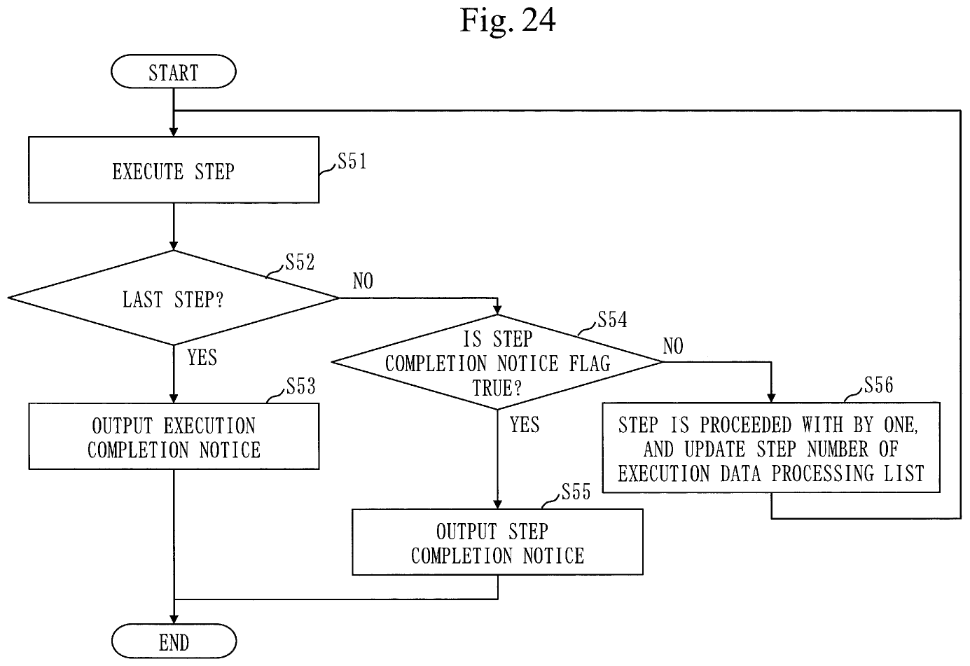

Next, with reference to FIG. 24, an example of operations of the engine execution unit 104 will be described.

In step S51, the engine execution unit 104 executes a step being an execution object.

Next, when the step executed in step S51 is completed, the engine execution unit 104 determines, in step S52, whether the said step is the last step in the data processing.

When the said step is the last step, the processing proceeds to step S53.

When the said step is not the last step, the processing proceeds to step S54.

In step S53, the engine execution unit 104 outputs an execution completion notice to the engine execution management unit 103.

In step S54, the engine execution unit 104 determines whether a step completion notice flag of the data processing being the object is TRUE in the execution data processing list 121.

When the step completion notice flag is TRUE, the processing proceeds to step S55.

Meanwhile, the step completion notice flag is FALSE, the processing proceeds to step S56.

In step S55, the engine execution unit 104 outputs a step completion notice to the engine execution management unit 103.

In step S56, the engine execution unit 104 proceeds with the step of the execution object by one, and updates a step number of the execution data processing list 121.

Then, the processing proceeds to step S51.

***Explanation of Effect of Embodiment***

As described above, according to the present embodiment, even if new data processing occurs due to an accidental event, it is possible to complete each of the new data processing and existing data processing by each deadline. Therefore, according to the present embodiment, it is possible to flexibly perform scheduling of data processing in response to change of a situation.

### Second Embodiment

In the present embodiment, explanations mainly of differences from the first embodiment will be provided.

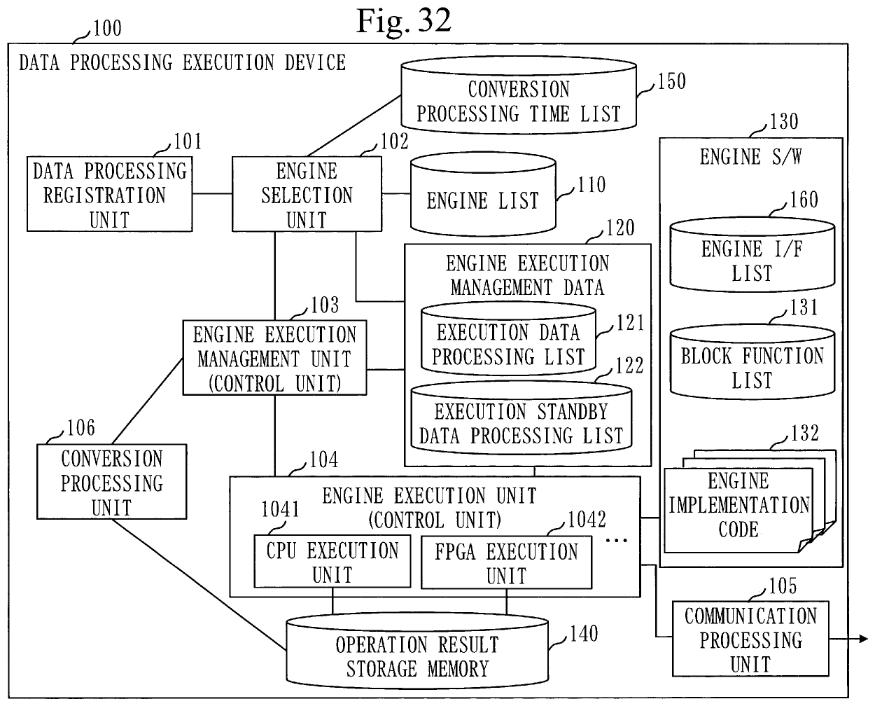

FIG. 32 illustrates an example of a function configuration of a data processing execution device 100 according to the present embodiment.

In comparison with FIG. 2, in FIG. 32, a conversion processing unit 106, a conversion processing time list 150 and an engine interface list 160 are added. The engine interface list 160 is also denoted by an engine I/F list 160.

The other elements are the same as those illustrated in FIG. 2.

The conversion processing unit 106 is realized by a program as is the case with the data processing registration unit 101, etc. The program to realize a function of the conversion processing unit 106 is executed by a processing circuit 900 as is the case with the data processing registration unit 101, etc.

When interface specifications differ between engines, the conversion processing unit 106 performs conversion processing to absorb differences in interface specifications. More specifically, when the interface specifications differ between an execution engine (for example, the engine 5A) and a takeover engine (for example, the engine 5B), the conversion processing unit 106 performs conversion processing to absorb differences in interface specifications.

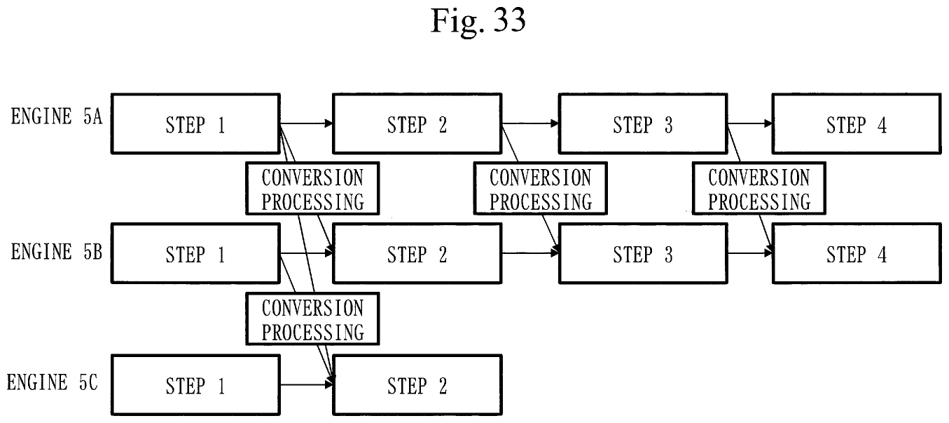

FIG. 33 illustrates a timing of conversion processing by the conversion processing unit 106.

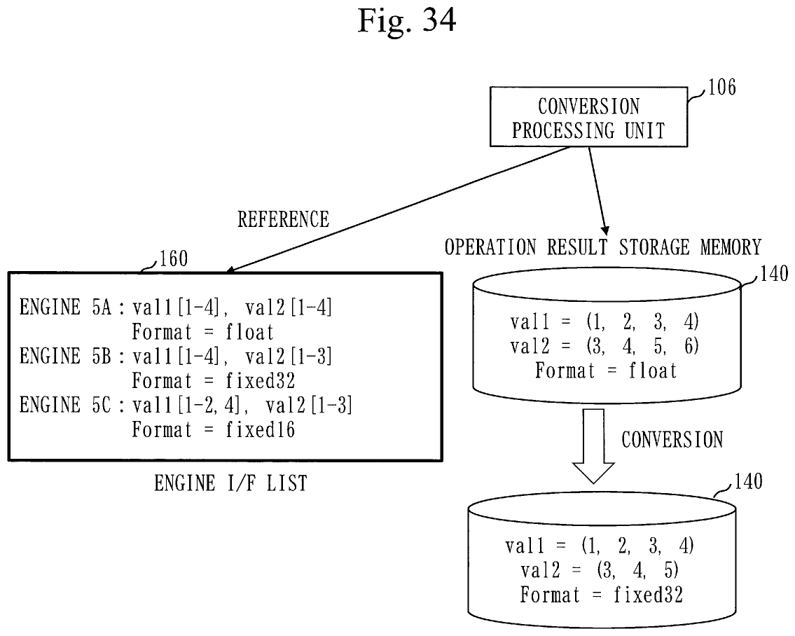

Further, FIG. 34 illustrates an example of conversion processing by the conversion processing unit 106.

FIG. 33 illustrates an example where the engine 5A, the engine 5B and the engine 5C execute steps included in the data processing 5. When the engine 5A executes the data processing 5, steps 1 through 4 are executed. When the engine 5B executes the data processing 5, the steps 1 through 4 are executed as well. When the engine 5C executes the data processing 5, the steps 1 and 2 are performed.

Furthermore, as illustrated in FIG. 34, the number of variable values, and variable types used for arithmetic operation differ among the engine 5A, the engine 5B and the engine 5C. The number of variable values and the variable types for each engine like this are defined in an engine interface list 160.

When all the steps of the data processing 5 are executed by a same engine, conversion processing by the conversion processing unit 106 is unnecessary. However, when antecedent and subsequent steps are executed by different engines, such that the step 1 is executed by the engine 5A, and the step 2 is executed by the engine 5B, conversion processing by the conversion processing unit 106 is necessary. That is, it is necessary for the conversion processing unit 106 to convert a result of an operation in an antecedent step to the number of variable values and variable types used in an engine to execute a subsequent step.

For example, it is assumed that an antecedent step is executed by the engine 5A, and a subsequent step is executed by the engine 5B.

In this case, as a result of an operation of the engine 5A, as illustrated in FIG. 34, an operation result storage memory 140 stores four values of val1 in a floating-point form, and four values of val2 in a floating-point form.

As illustrated in the engine interface list 160, the engine 5B uses four values for val1 and three values for va12, and the variable type is a 32-bit fixed point.

The engine execution management unit 103 calls the conversion processing unit 106 before calling an implementation function (a unique program code for the engine B) of the step performed by the engine 5B. The conversion processing unit 106 converts a result of an operation of the engine 5A stored in the operation result storage memory 140 so as to match the interface specifications of the engine 5B.

Specifically, as illustrated in FIG. 34, the conversion processing unit 106 converts the types of val1 and val2 to 32-bit fixed point, and decreases the value of va12 by 1. As a result, it is possible for the engine 5B to use the result of the operation stored in the operation result storage memory 140.

Further, as described above, since conversion processing by the conversion processing unit 106 occurs when switching between engines with different interface specifications occurs, it is necessary for the engine selection unit 102 to determine whether it is possible to complete execution data processing by a deadline, including a time required for the conversion processing by the conversion processing unit 106.

That is, in the present embodiment, the engine selection unit 102 selects, as a takeover engine, an engine capable of completing execution data processing, new data processing and assigned data processing by respective deadlines, including a time required for conversion processing.

The time required for conversion processing by the conversion processing unit 106 is indicated in the conversion processing time list 150.

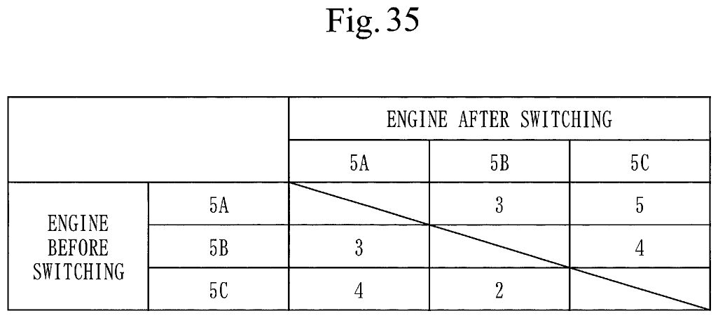

FIG. 35 illustrates an example of the conversion processing time list 150. Each numerical value indicates a time required for conversion processing. Further, each numerical value is denoted by a count value as is the case with the step start time in FIG. 5.

In the example of FIG. 35, in a case of switching from the engine 5A to the engine 5B, the time required for conversion processing by the conversion processing unit 106 is 3.

The conversion processing unit 106 obtains a time required for conversion processing by the conversion processing unit 106 by referring to the conversion processing time list 150.

As described, in the present embodiment, it is determined whether each of new data processing and existing data processing is completed by each deadline, including a time required for conversion processing. Therefore, according to the present embodiment, even when the interface specifications of an engine before switching and an engine after switching differ, it is possible to complete each of the new data processing and the existing data processing by each deadline.

The above describes the embodiments of the present invention; however, it is also applicable to combine and perform these two embodiments.

Meanwhile, it may be applicable to partially perform one of these two embodiments.

Otherwise, it may be applicable to partially combine and perform these two embodiments.

The present invention is not limited to these embodiments, and various modifications are possible as needed.

### REFERENCE SIGNS LIST

100: data processing execution device; 101: data processing registration unit; 102: engine selection unit; 103: engine execution management unit; 104: engine execution unit; 105: communication processing unit; 106: conversion processing unit; 110: engine list; 120: engine execution management data; 121: execution data processing list; 122: execution standby data processing list; 130: engine software; 131: block function list; 132: engine implementation code; 140: operation result storage memory; 150: conversion processing time list; 160: engine interface list; 900: processing circuit; 901: CPU; 902: RAM; 903: ROM; 904: hardware accelerator; 905: FPGA; 906: GPU; 907: DSP; 908: ASIC; 1041: CPU execution unit; 1042: FPGA execution unit

1. A data processing execution device comprising:
a plurality of engines, each of which executes data processing and has a different degree of operational accuracy; and
processing circuitry
to select, in a case where new data processing occurs in a situation where there exist execution data processing being data processing that is being executed by any engine of the plurality of engines and assigned data processing being data processing that is unexecuted, but to which an engine has been already assigned, and in a case where a priority degree is set to each of the execution data processing, the assigned data processing and the new data processing, a new engine to execute the execution data processing, a new engine to execute the assigned data processing and an engine to execute the new data processing, from among the plurality of engines, in such a way that each of the execution data processing, the assigned data processing and the new data processing is completed by each completion deadline and in such a way that data processing of a higher priority among the execution data processing, the assigned data processing and the new data processing is executed by an engine having a higher degree of operational accuracy; and
to make the execution data processing, the assigned data processing and the new data processing be executed by the engines selected

2. The data processing execution device as defined in claim 1, wherein
when at least any of the execution data processing, the assigned data processing and the new data processing is not completed by the each completion deadline, if execution of the execution data processing by an execution engine continues, the execution engine being currently executing the execution data processing,
the processing circuitry selects, as the new engine to execute the execution data processing, another engine than the execution engine, and as the new engine to execute the assigned data processing, another engine than the engine which has been already assigned to the assigned data processing.

3. The data processing execution device as defined in claim 1, wherein
in a case where the new data processing occurs in a situation where there exist the execution data processing, the assigned data processing and other execution data processing being data processing under execution other than the execution data processing, and in a case where a priority degree is set to each of the execution data processing, the assigned data processing, the other execution data processing and the new data processing,
the processing circuitry
selects the new engine to execute the execution data processing, the new engine to execute the assigned data processing, a new engine to execute the other execution data processing, and the engine to execute the new data processing, from among the plurality of engines, in such a way that each of the execution data processing, the assigned data processing, the other execution data processing and the new data processing is completed by each completion deadline and in such a way that data processing of a higher priority among the execution data processing, the assigned data processing, the other execution data processing and the new data processing is executed by an engine having a higher degree of operational accuracy, and
makes the execution data processing, the assigned data processing, the other execution data processing and the new data processing be executed by the engines selected.

4. The data processing execution device as defined in claim 1, wherein
before the new engine to execute the execution data processing is selected, the processing circuitry converts a common program code commonly provided for engines capable of executing the execution data processing, generates an individual program code for an execution engine which executes the execution data processing before selection of the new engine to execute the execution data processing, and makes the execution engine execute the execution data processing by using the individual program code for the execution engine generated, and wherein
when the new engine to execute the execution data processing is selected, the processing circuitry converts the common program code, generates an individual program code for the new engine, and makes the new engine take over the execution data processing by using the individual program code for the new engine generated.

5. The data processing execution device as defined in claim 1, wherein
the processing circuitry performs, when an interface specification differs between the new engine and an execution engine which is currently executing the execution data processing, conversion processing to absorb a difference of the interface specification.

6. The data processing execution device as defined in claim 5, wherein
when at least any of the execution data processing, the assigned data processing and the new data processing is not completed by the each completion deadline, if execution of the execution data processing by the execution engine continues,
the processing circuitry selects, the new engine to execute the execution data processing, the new engine to execute the assigned data processing and the engine to execute the new data processing, in such a way that each of the execution data processing, the assigned data processing and the new data processing is completed by the each completion deadline, including a time required for the conversion processing.

7. A data processing execution method, by a computer including a plurality of engines, each of which executes data processing and has a different degree of operational accuracy, performing:
selecting, in a case where new data processing occurs in a situation where there exist execution data processing being data processing that is being executed by any engine of the plurality of engines and assigned data processing being data processing that is unexecuted, but to which an engine has been already assigned, and in a case where a priority degree is set to each of the execution data processing, the assigned data processing and the new data processing, a new engine to execute the execution data processing, a new engine to execute the assigned data processing and an engine to execute the new data processing, from among the plurality of engines, in such a way that each of the execution data processing, the assigned data processing and the new data processing is completed by each completion deadline and in such a way that data processing of a higher priority among the execution data processing, the assigned data processing and the new data processing is executed by an engine having a higher degree of operational accuracy, and
making the execution data processing, the assigned data processing and the new data processing be executed by the engines selected.

8. A non-transitory computer readable medium storing a data processing execution program for causing a computer including a plurality of engines, each of which executes data processing and has a different degree of operational accuracy, to perform:
an engine selection process to select, in a case where new data processing occurs in a situation where there exist execution data processing being data processing that is being executed by any engine of the plurality of engines and assigned data processing being data processing that is unexecuted, but to which an engine has been already assigned, and in a case where a priority degree is set to each of the execution data processing, the assigned data processing and the new data processing, a new engine to execute the execution data processing, a new engine to execute the assigned data processing and an engine to execute the new data processing, from among the plurality of engines, in such a way that each of the execution data processing, the assigned data processing and the new data processing is completed by each completion deadline and in such a way that data processing of a higher priority among the execution data processing, the assigned data processing and the new data processing is executed by an engine having a higher degree of operational accuracy, and
a control process to make the execution data processing, the assigned data processing and the new data processing executed by the engines selected by the engine selection process.
